(19) United States
(12) Patent Application Publication
(10) Pub. No.: US 2007/0145625 A1
(43) Pub. Date: Jun. 28, 2007

(54) Process for crosslinking free-radical crosslinkable polymers

(75) Inventors: Paul J. Caronia, Annadale, NJ (US); Bharat I. Chaudhary, Princeton, NJ (US); Jeffrey M. Cogen, Flemington, NJ (US); Peter C. Dreux, Lumberton, NJ (US); Luke C. Du, Taipei City (TW); Neil W. Dunchus, Kinnelon, NJ (US); Mohamed Esseghir, Monroe, NJ (US); Robert W. Gowell, Flemington, NJ (US); Laurence H. Gross, Bridgewater, NJ (US); Suzanne M. Guerra, Hillsborough, NJ (US); Suh Joon Han, Belle Mead, NJ (US); Jinder Jow, Singapore (SG); John Klie, Midland, MI (US); Kawai P. Pang, Belle Mead, NJ (US); Timothy J. Person, Freehold, NJ (US); Miguel A. Prieto Goubert, Richterswil (CH)

Correspondence Address: THE DOW CHEMICAL COMPANY, INTELLECTUAL PROPERTY SECTION,, P. O. BOX 1967, MIDLAND, MI, 48641-1967, US

(73) Assignee: DOW GLOBAL TECHNOLOGIES INC., MIDLAND, MI (US)

(21) Appl. No.: 10/583,227

(22) PCT Filed: Dec. 24, 2004
(86) PCT No.: PCT/US04/43351

§ 371 Date: Jun. 16, 2006

Related U.S. Application Data
(60) Provisional application No. 60/532,491, filed on Dec. 24, 2003.
(60) Provisional application No. 60/612,986, filed on Sep. 24, 2004.

(51) Int. Cl. C08F 136/00

(52) U.S. Cl. 264/51; 525/331.9; 264/236

(57) ABSTRACT

The present invention is an improved free-radical crosslinking process and free-radical crosslinking polymer compositions. The improved process delivers hotter processing conditions, faster crosslinking, or increased crosslinked densities. The crosslinkable polymeric composition comprises (1) a free-radical crosslinkable polymer, (2) a free-radical inducing species, and (3) a crosslinking-temperature-profile modifier.

### FIELD OF THE INVENTION

This invention relates to polymer systems that undergo free radical crosslinking reactions. In particular, the invention relates to an improved free-radical crosslinking process and free-radical crosslinkable polymer compositions. The improved process delivers hotter processing conditions, faster crosslinking, or increased crosslinked densities.

### DESCRIPTION OF THE PRIOR ART

A number of polymers can undergo free radical reactions. Some of those reactions are beneficial such as crosslinking at the desired crosslinking temperature while others are detrimental such as premature crosslinking, competing, or degrading. There is a need to promote the beneficial crosslinking reaction while minimizing the impact of the detrimental reactions.

Generally, as free-radical crosslinkable polymers are processed for crosslinking purposes, the polymers follow a nominal crosslinking temperature profile. The nominal crosslinking temperature profile has three temperature-related portions: (1) a melt processing temperature portion; (2) a transitional temperature portion; and (3) a crosslinking temperature portion. The nominal crosslinking temperature profile is directly related to the characteristics of the polymer and the free-radical inducing species (or the crosslinking agent) selected. FIG. 1 illustrates a typical nominal crosslinking temperature profile.

To ensure that only the desired crosslinking reaction occurs, the melt processing temperature is kept low to avoid premature crosslinking. After the desired level of melt processing has occurred, the crosslinkable polymer and the free-radical inducing species are subjected to a transitional temperature portion to reach the nominal crosslinking temperature. If the free-radical species is an organic peroxide, the nominal crosslinking temperature is directly dependent upon the decomposition of temperature of the peroxide. Accordingly, the temperature range of the transitional temperature portion is determined by the nominal melt processing temperature on the low temperature end and by the nominal crosslinking temperature on the high temperature end.

It is important to note that in some applications, the melt processing may occur in a single-step or in more than one-step. For an example and as single step, the components may be added separately to the hopper of an extruder and melt blended together at a suitable melt processing temperature. An example of multi-step melt processing may include a first step wherein the components are blended together at a temperature above the melting temperature of the polymer but below the nominal decomposition temperature of the free-radical inducing species and a second step wherein the blended composition is transferred into an extruder for further processing. As used herein, the melt processing temperature is defined to include single step or multi-step melt processing techniques.

Because the crosslinking rate increases gradually with temperature, the temperature difference between the melt processing temperature portion and the crosslinking temperature portion (i.e., the transitional temperature portion) can be quite large, sometimes greater than about 60 degrees Celsius. While the crosslinking temperature changes with the choice of free-radical inducing species, the corresponding temperature range of the transitional temperature portion is generally unaffected. Therefore, a change in the crosslinking temperature typically requires a corresponding change in the melt processing temperature.

For example, in injection molding applications, a low injection temperature (i.e., melt processing temperature portion) is required because common organic peroxides decompose over a broad temperature range. For example, practitioners commonly inject crosslinkable polymer compositions containing ethylene/propylene/diene monomer-based polymers and the organic peroxide dicumyl peroxide into a mold at about 100 degrees Celsius and then cure the compositions in the mold with wall temperature set at about 165 degrees Celsius (i.e., crosslinking temperature portion). As such, the crosslinking process has a large range for the transitional temperature of about 65 degrees Celsius, which results in a very long nominal crosslinking temperature profile time, particularly for thick parts. The nominal crosslinking temperature profile restricts injection molding to those crosslinkable polymers having a suitable melting temperature or viscosity profile.

Similarly, in some applications, practitioners extrude crosslinkable polymer compositions at temperatures no higher than 140 degrees Celsius and then pass the resulting fabricated articles through a continuous vulcanization tube at a higher crosslinking temperature, typically in excess of 200 degrees Celsius, to complete crosslinking. Because shear heating from extruder screw speed can induce premature crosslinking, the screw speed is maintained at a low rate and extrusion outputs are limited.

With free-radical crosslinkable ethylene/propylene/diene monomer-based polymers or ethylene/propylene rubbers, the crosslinkable compositions are typically extruded at a temperature no higher than about 120 degrees Celsius with the extruded article ultimately passing through a continuous vulcanization tube at a temperature of about 210 degrees Celsius. Similarly, free-radical crosslinkable flame retardant polyolefin-based compositions are typically extruded at a temperature no higher than about 140 degrees Celsius with the extruded article ultimately passing through a continuous vulcanization tube at a temperature of about 200-210 degrees Celsius.

With free-radical crosslinkable chlorinated polyethylene, an example of a fabrication method is extrusion. Typically, crosslinkable polymeric compositions containing chlorinated polyethylene are melt-processed in a batch mixer and then subjected to crosslinking conditions in a continuous vulcanization tube, usually at about 200 degrees Celsius.

When these chlorinated polyethylene compositions are filled with small particle-size fillers such as carbon black and silica, intensive mixing is required.

Unfortunately, the intensive mixing is limited by temperature and time to avoid premature crosslinking. In fact, the temperature is often maintained at no higher than 100 degrees Celsius. Also, because shear heating from the extruder screw can also induce premature crosslinking, extrusion output rates are limited.

The transitional temperature for chlorinated polyethylene compositions represents about a 100-degree Celsius temperature range. This temperature difference negatively impacts the line speed and contributes to a long residence time in the continuous vulcanization tube.

To increase injection temperatures or extrusion rates without premature crosslinking, practitioners add scorch inhibitors or antioxidants to the compositions.

Unfortunately, this approach increases the cycle time to achieve a desired level of crosslinking (i.e., cure rate is decreased). To overcome the cure rate reduction, practitioners use longer continuous vulcanization tubes when extruding the polymer or sophisticated formulations of the composition for injection molded or extruded polymers.

Accordingly, the need exists for an improved process for crosslinking free-radical crosslinkable polymers. The improved process must permit a higher melting temperature portion than presently achieved in conventional processes while maintaining the present levels of premature crosslinking or further minimizing premature crosslinking. Similarly, the improved process must permit higher extrusion screw rates than presently practiced in conventional processes without any appreciably negative impact upon premature crosslinking.

There is also a need for an improved process for crosslinking free radical crosslinkable polymers wherein the temperature range of the transitional temperature portion is significantly smaller than provided in conventional processes, also without negatively impacting premature crosslinking. A smaller temperature range will yield a faster process because the transitional heating of the polymer is minimized.

It is also desirable that the transitional temperature portion increase as sharply as possible and approach an infinite slope. Moreover, it is desirable that the crosslinking temperature portion have a slope of as near zero as possible.

In the context of processing expandable, free-radical crosslinkable polymeric compositions, the crosslinking temperature profile is complicated by premature crosslinking as well as expansion of the composition within the range between the melt processing temperature and the crosslinking temperature. There is a need to minimize the impact of premature crosslinking, control the onset/completion of expansion, and yield a faster crosslinking process.

For some molded applications, there is also the need to minimize expansion of the foamed article after release from the mold, preferably to control post-expansion to less than about 1.5 volume percent. More preferably, it is desirable to control post-expansion without appending functional groups to the free-radical crosslinkable polymers.

Each of these needed process improvements should be achievable without significantly modifying the conventional crosslinking equipment. Notably, the needed improvement should not require longer continuous vulcanization tubes for extruded crosslinkable polymer articles.

Ultimately, there is a need for a higher melt temperature portion for free-radical crosslinkable polymers and a need for a faster crosslinking process without having a detrimental effect on the properties of the articles made by the improved process.

There is also a need for free-radical crosslinkable polymer compositions with enhanced processing and physical properties. In particular, there is a need for free-radical crosslinkable polymer compositions with excellent melt processing characteristics without premature crosslinking. In some instances, it is further desirable that the compositions also have excellent melt strength.

### SUMMARY OF THE INVENTION

The present invention is an improved process for crosslinking polymers, wherein the improved process delivers hotter processing conditions, faster crosslinking, or increased crosslinked densities. The invented process comprises the steps of (a) melt processing a crosslinkable polymeric composition, (b) forming an article of manufacture from the crosslinkable polymeric composition, and (c) crosslinking the crosslinkable polymeric composition as a formed article of manufacture. The crosslinkable polymeric composition comprises (1) a free-radical crosslinkable polymer, (2) a free-radical inducing species, and (3) a crosslinking-temperature-profile modifier.

The melt processing step or the crosslinking step occurs at a temperature higher than conventionally used for crosslinking polymers. The increased temperatures permit crosslinking of previously excluded polymers (due to high melting temperatures). The increased temperatures also permit rate improvements over the crosslinking profile.

The present invention is also a free-radical crosslinkable polymer composition having excellent melt processing and physical properties. The invented composition comprises (1) a free-radical crosslinkable polymer or blend having poor melt processing properties at nominal melt processing temperatures, (2) a free-radical inducing species, and (3) a crosslinking-temperature-profile modifier. The crosslinking-temperature-profile modifier enables melt processing the free-radical crosslinkable polymer or blend at a temperature higher than nominal melt processing temperatures without premature crosslinking.

### BRIEF DESCRIPTION OF DRAWING

FIG. 1 shows a nominal crosslinking temperature profile for a combination of a free-radical crosslinkable polymer compositions and a free-radical inducing species.

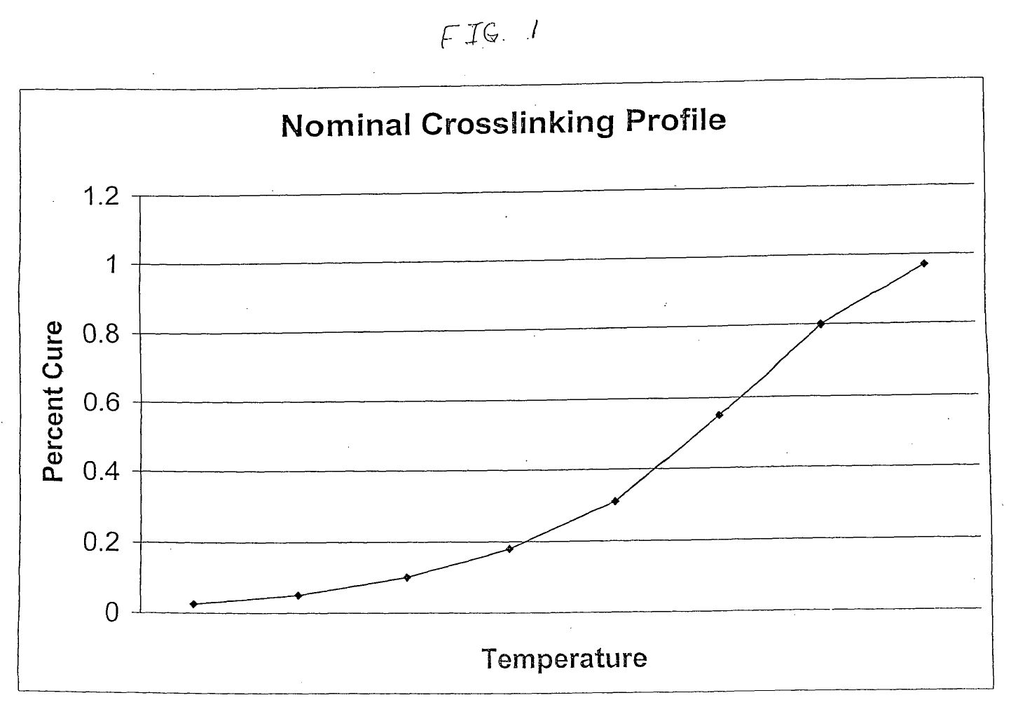

FIG. 2 shows torque-time curves at 140 degrees Celsius for crosslinkable polymeric compositions with and without a crosslinking-temperature-profile modifier.

FIG. 3 shows torque-time curves at 180 degrees Celsius for crosslinkable polymeric compositions with and without a crosslinking-temperature-profile modifier.

FIG. 4 shows torque-time curves at 140 degrees Celsius for the commercially-available SuperOhm™ 3728 peroxide-crosslinkable composition with and without a crosslinking-temperature-profile modifier.

FIG. 5 shows torque-time curves at 180 degrees Celsius for the commercially-available SuperOhm™ 3728 peroxide-crosslinkable composition with and without a crosslinking-temperature-profile modifier.

FIG. 6 shows torque-time curves at 150 degrees Celsius for a high density polyethylene (a) as a base polymer, (b) with peroxide, and (c) with peroxide and a crosslinking-temperature-profile modifier.

FIG. 7 shows torque-time curves at 140 degrees Celsius and 150 degrees Celsius for crosslinkable polymeric compositions with and without a crosslinking temperature-profile modifier.

FIG. 8 shows torque-time curves at 182 degrees Celsius for crosslinkable polymeric compositions with and without a crosslinking temperature-profile modifier.

FIG. 9 shows percent peroxide decomposition at various temperatures for crosslinkable polymeric compositions with and without a crosslinking temperature-profile modifier.

FIG. 10 shows spectra from Attenuated Total Reflectance infrared scans of the surface of test specimens prepared from compositions containing a crosslinking-temperature-profile modifier.

FIG. 11 shows torque-time curves at 140 degrees Celsius for crosslinkable polymeric compositions with and without a crosslinking temperature-profile modifier.

FIG. 12 shows torque-time curves at 177 degrees Celsius for crosslinkable polymeric compositions with and without a crosslinking temperature-profile modifier.

FIG. 13 shows torque-time curves at 165 degrees Celsius for injection-moldable, crosslinkable polymeric compositions with various levels of a crosslinking-temperature-profile modifier.

FIG. 14 shows torque-time curves at 185 degrees Celsius for injection-moldable, crosslinkable polymeric compositions with various levels of a crosslinking-temperature-profile modifier.

FIG. 15 shows torque-time curves at 140 degrees Celsius for crosslinkable polymeric compositions with and without a crosslinking temperature-profile modifier.

FIG. 16 shows torque-time curves at 182 degrees Celsius for crosslinkable polymeric compositions with and without a crosslinking temperature-profile modifier.

FIG. 17 shows torque-time curves at 140 degrees Celsius for crosslinkable polymeric compositions with and without a crosslinking temperature-profile modifier.

FIG. 18 shows torque-time curves at 182 degrees Celsius for crosslinkable polymeric compositions with and without a crosslinking temperature-profile modifier.

FIG. 19 shows torque-time curves at 120 degrees Celsius for crosslinkable polymeric compositions with and without a crosslinking temperature-profile modifier.

FIG. 20 shows torque-time curves at 140 degrees Celsius for crosslinkable polymeric compositions with and without a crosslinking temperature-profile modifier.

FIG. 21 shows torque-time curves at 182 degrees Celsius for crosslinkable polymeric compositions with and without a crosslinking temperature-profile modifier.

FIG. 22 shows torque-time curves at 140 degrees Celsius for crosslinkable polymeric compositions with and without a crosslinking temperature-profile modifier.

FIG. 23 shows torque-time curves at 182 degrees Celsius for crosslinkable polymeric compositions with and without a crosslinking temperature-profile modifier.

### DESCRIPTION OF THE INVENTION

In a first embodiment, the invented process for preparing a crosslinked article of manufacture comprises the steps of (a) melt processing a crosslinkable polymeric composition, (b) forming an article of manufacture from the crosslinkable polymeric composition, and (c) crosslinking the crosslinkable polymeric composition as a formed article of manufacture. The crosslinkable polymeric composition comprises (1) a free-radical crosslinkable polymer, (2) a free-radical inducing species, and (3) a crosslinking-temperature-profile modifier.

In the absence of the crosslinking-temperature-profile modifier, the combination of the free-radical crosslinkable polymer and the free-radical inducing species has a nominal crosslinking temperature profile. The nominal crosslinking temperature profile comprises a nominal melt processing temperature portion, a nominal transitional temperature portion, and a nominal crosslinking temperature portion.

The crosslinking-temperature-profile modifier permits raising the temperature of the melt processing temperature portion and reducing the transitional temperature portion. Accordingly, in the invented process, the melt processing step occurs at a temperature greater than nominal melt processing temperature of the combination. The crosslinking-temperature-profile modifier substantially suppresses premature crosslinking of the free-radical crosslinkable polymer at the melt processing temperature. For example, when the free-radical inducing species is an organic peroxide with an appreciable rate of decomposition at the melt processing temperature, the crosslinking-temperature-profile modifier suppresses premature crosslinking of the polymer.

The combination of the free-radical crosslinkable polymer and the free-radical inducing species (without a crosslinking-temperature-profile modifier) achieves a nominal induction time (t_{0.04n}) at the nominal melt processing temperature. The “nominal induction time,” as used herein, means the amount of time required for the torque value as measured by a moving die rheometer (MDR) to increase by 0.04 pound-inches above the minimum torque at the nominal melt processing temperature, 100 cycles per minute, and an arc of 0.5 degrees. The nominal induction time is alternatively termed the time to the onset of torque increase (tₒₙₛₑₜ).

At the nominal melt processing temperature, the crosslinkable polymeric composition achieves an improved induction time (t_{0.04i}) of at least 2-fold greater than the nominal induction time. Preferably, the improved induction time is at least 3-fold greater than the nominal induction time. More preferably, the improved induction time is at least 5-fold greater.

At the elevated melt processing temperature, the crosslinkable polymeric composition maintains an induction time equal to or greater than the nominal induction time.

Preferably, the crosslinkable polymeric composition achieves the same degree of cure or a higher degree of cure than the combination would achieve in the absence of the crosslinking-temperature-profile modifier.

While the induction time can generally facilitate describing the improved process, TS1 is a useful attribute for determining premature crosslinking for certain crosslinkable polymeric compositions. “TS1,” as used herein, means the amount of time required for the torque value as measured by a moving die rheometer (MDR) to increase by 1.0 pound-inches above the minimum torque at the nominal melt processing temperature, 100 cycles per minute, and an arc of 0.5 degrees. Generally, TS1 would be used with those crosslinkable polymeric compositions having (a) a nominal induction time of less than 1 minute at the nominal melt processing temperature, (b) a difference of M_{H} and M_{L} at least greater than 1 pound-inches (i.e., M_{H}−M_{L}>1 at the nominal melt processing temperature, and/or (c) a maximum torque (M_{H}) at the nominal crosslinking temperature substantially greater than 1 pound-inch.

Preferably and in the absence of the crosslinking temperature profile modifier, those compositions have a TS1 greater than about 20 minutes at their nominal melt processing temperature. In those compositions, the crosslinking-temperature profile modifier permits the crosslinkable polymeric composition to achieve at least the same TS1 at a melt processing temperature greater than the nominal melt processing temperature. Preferably, the transitional temperature portion (i.e., the temperature difference between the melt processing temperature and the crosslinking temperature) can be decreased by at least 5 percent while maintaining a desirable TS1.

The present invention is useful in wire-and-cable, footwear, film (e.g. greenhouse, shrink, and elastic), engineering thermoplastic, highly-filled, flame retardant, reactive compounding, thermoplastic elastomer, thermoplastic vulcanizate, automotive, vulcanized rubber replacement, construction, automotive, furniture, foam, wetting, adhesive, paintable substrate, dyeable polyolefin, moisture-cure, nanocomposite, compatibilizing, printing, steel replacement, wax, sizing, calendared sheet, medical, dispersion, coextrusion, cement/plastic reinforcement, food packaging, non-woven, paper-modification, multilayer container, sporting good, oriented structure, and surface treatment applications. Suitable articles of manufacture include power cable insulations (including insulations for extra high voltage (EHV), high voltage (HV), medium voltage (MV), and low voltage (LV) applications), wire-and-cable semiconductive articles (including semiconductive insulation shields), wire-and-cable coatings (including flame retardant automotive wire insulations) and jackets (including industrial cable jackets), cable accessories, shoe soles, multicomponent shoe soles (including polymers of different densities and type), weather stripping, gaskets, profiles, durable goods, rigid ultradrawn tape, run flat tire inserts, construction panels, composites (e.g., wood composites), pipes, foams, and fibers (including binder fibers and elastic fibers).

A variety of polymers is useful in the present invention. Moreover, many polymers that were heretofore unsuitable for free-radical crosslinking are useful in the present invention. Notably, polymers having a high melting temperature are now suitable for free-radical crosslinking. In particular, the present invention is useful with free-radical crosslinking polymers having a melting temperature equal to or greater than about 130 degrees Celsius or a short nominal induction time. An example of a free-radical crosslinking polymer having a high melting temperature is high density polyethylene. For example, the present invention is particularly useful for combinations of a free-radical crosslinkable polymer and a free-radical inducing species that have a nominal induction time of less than about 5 minutes or even less than about one minute.

Preferably, the free-radical crosslinkable polymer is hydrocarbon-based. Suitable hydrocarbon-based polymers include ethylene/propylene/diene monomers, ethylene/propylene rubbers, ethylene/alpha-olefin copolymers, ethylene homopolymers, ethylene/unsaturated ester copolymers, ethylene/styrene interpolymers, halogenated polyethylenes, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof.

More preferably, the hydrocarbon-based polymer is selected from the group consisting of ethylene/propylene/diene monomers and ethylene/propylene rubbers. Even more preferably, when the hydrocarbon-based polymer is one of these preferable polymers or a blend thereof, the free-radical crosslinkable polymer is present in an amount between about 20 weight percent and about 90 weight percent, the free-radical inducing species is present in an amount between about 0.5 weight percent and 10 weight percent, and the crosslinking-temperature profile modifier is present in amount between about 0.1 weight percent and about 5 weight percent, and the free-radical crosslinkable polymeric composition further comprises inorganic fillers in an amount between about 10 weight percent and about 70 weight percent.

Also, more preferably, the hydrocarbon-based polymer is selected from the group consisting of ethylene/alpha-olefin copolymers and ethylene/unsaturated ester copolymers. Even more preferably, when the hydrocarbon-based polymer is one of these preferable polymers or a blend thereof, the free-radical crosslinkable polymer is present in an amount between about 10 weight percent and about 85 weight percent, the free-radical inducing species is present in an amount between about 0.5 weight percent and 10 weight percent, and the crosslinking-temperature profile modifier is present in amount between about 0.1 weight percent and about 5 weight percent, and the free-radical crosslinkable polymeric composition further comprises flame retardant additives in an amount between about 15 weight percent and about 70 weight percent.

With regard to the suitable ethylene polymers, the free-radical crosslinkable polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between about 0.910 grams per cubic centimeter and about 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between about 0.850 grams per cubic centimeter and about 0.940 grams per cubic centimeter and a melt index between about 0.01 to about 100 grams per 10 minutes as measured by ASTM 1238, condition I. Preferably, the melt index is between about 0.1 to about 50 grams per 10 minutes. Also, preferably, the LLDPE is an interpolymer of ethylene and one or more other alpha-olefins having from 3 to 18 carbon atoms, more preferably from 3 to 8 carbon atoms.

Preferred comonomers include 1-butene, 4-methyl-1-pentene, 1-hexene, and 1-octene. Ultra-low density polyethylene and very low density polyethylene are known interchangeably. These polymers have a density between about 0.870 grams per cubic centimeter and about 0.910 grams per cubic centimeter. High density ethylene polymers are generally homopolymers with a density between about 0.941 grams per cubic centimeter and about 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between about 0.850 grams per cubic centimeter and about 0.970 grams per cubic centimeter. Preferably, the density is between about 0.85 grams per cubic centimeter and about 0.955 grams per cubic centimeter, more preferably, between about 0.850 grams per cubic centimeter and 0.920 grams per cubic centimeter.

Ethylene/styrene interpolymers useful in the present invention include substantially random interpolymers prepared by polymerizing an olefin monomer (i.e., ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include norbornene and C₁₋₁₀ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of about 5 to about 50 percent by weight based on the weight of the copolymer, and is preferably in the range of about 10 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples, of the vinyl carboxylates are vinyl acetate, vinyl propionate, and vinyl butanoate. The melt index of the ethylene/unsaturated ester copolymers can be in the range of about 0.5 to about 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Even more preferably, when the halogenated olefin polymer is a chlorinated polyethylene, the free-radical crosslinkable polymer is present in an amount between about 20 weight percent and about 90 weight percent, the free-radical inducing species is present in an amount between about 0.5 weight percent and 10 weight percent, and the crosslinking-temperature profile modifier is present in amount between about 0.1 weight percent and about 5 weight percent, and the free-radical crosslinkable polymeric composition further comprises inorganic fillers in an amount between about 10 weight percent and about 65 weight percent. This even more preferred composition is useful for flame retardant polyolefin-based compositions.

The present invention is particularly beneficial when the free-radical crosslinkable polymer is a propylene polymer because the crosslinking-temperature-profile modifier can suppress chain scission of the propylene polymer.

Examples of propylene polymers useful in the present invention include copolymers of propylene with ethylene or another unsaturated comonomer. Copolymers also include terpolymers, tetrapolymers, etc. Typically, the polypropylene copolymers comprise units derived from propylene in an amount of at least about 50 weight percent. Preferably, the propylene monomer is at least about 60 weight percent of the copolymer, more preferably at least about 70 weight percent.

Natural rubbers suitable in the present invention include high molecular weight polymers of isoprene. Preferably, the natural rubber will have a number average degree of polymerization of about 5000 and a broad molecular weight distribution.

Useful styrene/butadiene rubbers include random copolymers of styrene and butadiene. Typically, these rubbers are produced by free radical polymerization. Styrene/butadiene/styrene block copolymers of the present invention are a phase-seperated system. The styrene/ethylene/butadiene/styrene copolymers useful in the present invention are prepared from the hydrogenation of styrene/butadiene/styrene copolymers.

The polybutadiene rubber useful in the present invention is preferably a homopolymer of 1,4-butadiene. Preferably, the butyl rubber of the present invention is a copolymer of isobutylene and isoprene. The isoprene is typically used in an amount between about 1.0 weight percent and about 3.0 weight percent.

For the present invention, polychloroprene rubbers are generally polymers of 2-chloro-1,3-butadiene. Preferably, the rubber is produced by an emulsion polymerization. Additionally, the polymerization can occur in the presence of sulfur to incorporate crosslinking in the polymer.

Preferably, the nitrile rubber of the present invention is a random copolymer of butadiene and acrylonitrile.

Other useful free-radical crosslinkable polymers include silicone rubbers and fluorocarbon rubbers. Silicone rubbers include rubbers with a siloxane backbone of the form —Si—O—Si—O—. Fluorocarbon rubbers useful in the present invention include copolymers or terpolymers of vinylidene fluoride, hexafluoropropylene, and tetrafluoroethylene with a cure site monomer to permit free-radical crosslinking.

Useful free-radical inducing species include organic peroxides, Azo free radical initiators, bicumene, oxygen, and air. Preferably, the free-radical inducing species is an organic peroxide. Preferable organic peroxides include dicumyl peroxide and Vulcup R. The organic peroxide can be added via direct injection. Oxygen-rich environments can initiate useful free-radicals. Preferably, the free-radical inducing species is present in an amount between about 0.5 weight percent and about 10 weight percent, more preferably, between about 0.5 weight percent and about 5.0 weight percent, and even more preferably, between about 0.5 weight percent and about 2.0 weight percent.

Useful examples of the crosslinking-temperature-profile modifier are free radical inhibitors such as (i) hindered amine-derived stable organic free radicals, (ii) iniferters, (iii) organometallic compounds, (iv) aryl azooxy radical, and (v) nitroso compounds. When induction time is appropriate for describing the improved process, selection of crosslinking temperature profile modifiers is based upon determining whether the modifier will impart at least a 2-fold greater induction time over the nominal induction time. When TS1 is a more appropriate measure, the desired improvement is application specific. However, at the nominal melt processing temperature, it is desirable to increase (a) the induction time to greater than at least 2 minutes or (b) the time required to achieve MH by at least 5 percent.

Suitable hindered amine-derived stable organic free radicals include 2,2,6,6,-tetramethyl piperidinyl oxy (TEMPO) and its derivatives. More preferably, hindered amine-derived stable organic free radicals are bis-TEMPOs, oxo-TEMPO, 4-hydroxy-TEMPO, an ester of 4-hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, or a metal complex with TEMPO. Even more preferably, hindered amine-derived stable organic free radical is a bis-TEMPO or 4-hydroxy-TEMPO. An example of a bis-TEMPO is bis(1-oxyl-2,2,6,6-tetramethylpiperidine-4-yl)sebacate.

Iniferters are compounds capable of initiating and terminating free radical reactions. They are also capable of reversibly terminating growing polymer chains. When the crosslinking-temperature profile modifier is an iniferter, it is preferably selected from the group consisting of tetraethyl thiuram disulfide, benzyl NN diethyldithiocarbamate, dithiocarbamates, polythiocarbamates, and S benzyl dithiocarbamate.

Preferably, the crosslinking-temperature profile modifier is present in an amount between about 0.1 weight percent and about 5.0 weight percent. More preferably, it is present between 0.1 weight percent and about 2 weight percent, even more preferably, between 0.1 weight percent and about 1 weight percent. More preferably, the free-radical inducing species to the free-radical trapping species are present in a ratio greater than about 1, more preferably, between about 20:1 to about 1:1.

The crosslinking-temperature profile modifier and free-radical inducing species can be combined with the free-radical crosslinkable polymer in a variety of ways, including direct compounding, direct soaking, and direct injection.

The crosslinkable polymeric composition can also contain an organic crosslinking modifier not having a carbon-carbon double bond, wherein the organic crosslinking modifier and the crosslinking-temperature profile modifier synergistically (a) suppress the crosslinking rate of the free-radical crosslinkable polymer at temperatures less than the nominal cure temperature of the free-radical inducing species and (b) enhance the crosslinking density at the nominal cure temperature of the free-radical inducing species. Preferably, the organic crosslinking modifier is tris(2,4-di-tert-butylphenyl)phosphite, poly[[6-[(1,1,3,3,-tetramethyl-butyl)amino]-s-triazine-2,4-diyl][2,2,6,6,-tetramethyl-4-piperidyl)imino]hexamethylene[2,2,6,6-tetramethyl-4-piperidyl)imino)], 2(2′-hydroxy-3′,5′-di-tert-amylphenyl)benzotriazole, or blends thereof.

The crosslinkable polymeric composition can also contain a nonpolar additive, wherein the additive enhances the crosslinking performance without contributing to the migration of the crosslinking-temperature profile modifier to the surface of an article of manufacture prepared from the crosslinkable polymeric composition. Examples include decadiene and polybutadiene.

The crosslinkable polymeric composition can also contain a cure booster or a coagent to enhance the crosslinking performance of the free-radical inducing species, without increasing the amount of the free-radical inducing species. Crosslinking performance enhancements can include decreasing the cycle time of the process (i.e., increasing the cure rate) and increasing the crosslinking density (i.e., cure degree). The addition of a cure booster is particularly useful when the free-radical crosslinkable polymer is a chlorinated polyethylene. In some cases, the coagents may serve a dual role as cure booster and scorch retarder. Useful cure boosters include polyvinyl agents and certain monovinyl agents such as alpha methyl styrene dimer, allyl pentaerythritol (or pentaerythritol triacrylate or triallyl pentaerythritol), TAC, TAIC, 4-allyl-2-methoxyphenyl allyl ether, and 1,3-di-isopropenylbenzene. Some of those cure boosters and other useful cure boosters have the following chemical structures.

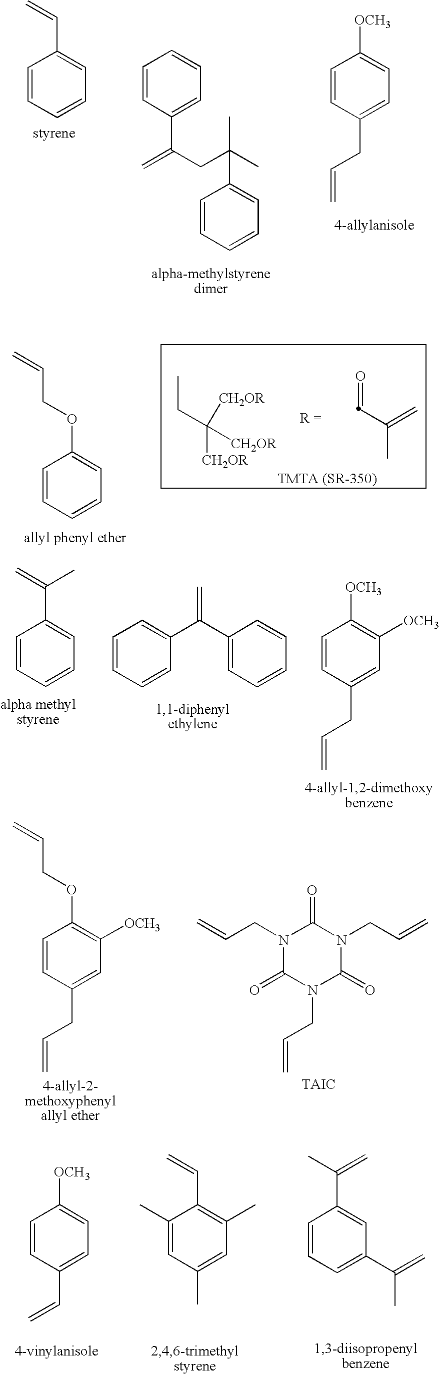

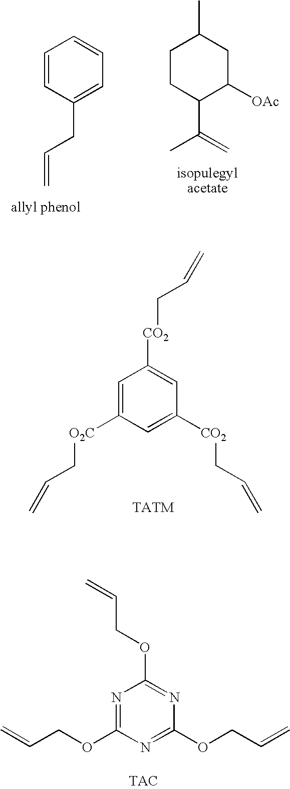

The crosslinkable polymeric composition can also contain catalysts for increasing free-radical formation. Suitable examples of catalysts include tertiary amines, cobalt naphthenate, manganese naphthenate, vanadium pentoxide, and quaternary ammonium salt.

The crosslinkable polymeric composition can also contain a chemical or physical blowing agent, thereby rendering the crosslinkable polymeric composition expandable. Preferably, the blowing agent will be a chemical blowing agent. An example of a useful chemical blowing agent is azodicarbonamide.

Other additives are useful with the crosslinkable polymeric composition of the present invention. Those additives include scorch inhibitors, antioxidants, fillers, clays, organoclays, processing aids, carbon black, flame retardants, peroxides, dispersion agents, waxes, coupling agents, mold release agents, light stabilizers, metal deactivators, plasticizers, antistatic agents, whitening agents, nucleating agents, other polymers, and colorants. The crosslinkable polymeric compositions can be highly filled.

Other suitable non-halogenated flame retardant additives include alumina trihydrate, magnesium hydroxide, red phosphorus, silica, alumina, titanium oxides, melamine, calcium hexaborate, alumina, carbon nanotubes, wollastonite, mica, silicone polymers, phosphate esters, hindered amine stabilizers, ammonium octamolybdate, intumescent compounds, melamine octamolybdate, frits, hollow glass microspheres, talc, clay, organo-modified clay, zinc borate, antimony trioxide, and expandable graphite. Suitable halogenated flame retardant additives include decabromodiphenyl oxide, decabromodiphenyl ethane, ethylene-bis (tetrabromophthalimide), and dechlorane plus.

In a preferred embodiment, the present invention is an improved process for preparing a crosslinked article of manufacture. The crosslinking-temperature-profile modifier permits raising the temperature of the melt processing temperature above the nominal melt processing temperature and the temperature of the crosslinking temperature portion above the nominal crosslinking temperature. Accordingly, in the invented process, the melt processing step occurs at a temperature greater than the nominal melt processing temperature and the crosslinking step occurs at a temperature greater than the nominal crosslinking temperature.

The combination of the free-radical crosslinkable polymer and the free-radical inducing species achieves a nominal induction time (t_{0.04n}) at the nominal melt processing temperature. At the nominal melt processing temperature, crosslinkable polymeric composition achieves an improved induction time (t_{0.04i}) of at least 2-fold greater than the nominal induction time. Preferably, the improved induction time is at least 3-fold greater than the nominal induction time. More preferably, the improved induction time is at least 5-fold greater.

At the elevated melt processing temperature, the crosslinkable polymeric composition maintains an induction time equal to or greater than the nominal induction time.

In yet another preferred embodiment, the present invention is an improved process for preparing a crosslinked article of manufacture. In the absence of the crosslinking-temperature-profile modifier, the combination of the free-radical crosslinkable polymer and the free-radical inducing species has a nominal crosslinking temperature profile and a nominal processing rate.

The crosslinking-temperature-profile modifier permits running the process at least about 5 percent faster than the nominal processing rate. The combination also achieves an improved induction time (t_{0.04i}) of at least 2-fold greater than the nominal induction time at the nominal melt processing temperature. Furthermore, the combination and the crosslinking-temperature-profile modifier achieve an induction time equal to or greater than the nominal induction time at a melt processing temperature higher than the nominal melt processing temperature (higher-rate melt processing temperature). The higher-rate melt processing temperature is required to achieve the faster processing rate.

In this embodiment, the crosslinkable polymeric composition is melt processed at the higher-rate melt processing temperature. More preferably, the crosslinking step occurs at a temperature greater than the nominal crosslinking temperature.

In another preferred embodiment, the present invention is an invented process for preparing a crosslinked article of manufacture comprising the steps of (a) melt processing a crosslinkable polymeric composition, (b) forming an article of manufacture from the crosslinkable polymeric composition, and (c) crosslinking the crosslinkable polymeric composition as a formed article of manufacture. The crosslinkable polymeric composition comprises (1) a free-radical crosslinkable polymer that forms free radicals when subjected to shear energy, heat, or radiation, and (2) a crosslinking-temperature-profile modifier.

In the absence of the crosslinking-temperature-profile modifier, the combination of the free-radical crosslinkable polymer, when subjected to shear energy, heat, or radiation, has a nominal crosslinking temperature profile. The nominal crosslinking temperature profile comprises a nominal melt processing temperature portion, a nominal transitional temperature portion, and a nominal crosslinking temperature portion.

The crosslinking-temperature-profile modifier permits raising the temperature of the melt processing temperature portion and reducing the transitional temperature portion. Accordingly, in the invented process, the melt processing step occurs at a temperature greater than nominal melt processing temperature of the combination. The melt processing temperature may be increased by increasing the shear energy or the amount of radiation affecting the free-radical crosslinking polymer. Specifically, this preferred embodiment is particular useful in extrusion applications, wherein the screw speed is set at a higher rate to increase throughput.

The combination achieves a nominal induction time at the nominal melt processing temperature. At the nominal melt processing temperature, the crosslinkable polymeric composition achieves an improved induction time of at least 2-fold greater than the nominal induction time. Preferably, the improved induction time is at least 3-fold greater than the nominal induction time. More preferably, the improved induction time is at least 5-fold greater.

In an alternate embodiment of the present invention, the invention is a process for preparing an article of manufacture comprising the steps of (a) injecting at an injection temperature an expandable, free-radical crosslinkable polymeric composition into a mold at a mold temperature; (b) heating the expandable, crosslinkable polymeric composition for a period of time to a crosslinking temperature sufficient to expand and crosslink the expandable, crosslinkable polymeric composition; (c) removing the expandable, crosslinkable polymeric composition from the mold; and (d) expanding and crosslinking the expandable, crosslinkable polymeric article to an expanded, crosslinked article of manufacture.

In the present embodiment, the melt processing temperature would encompass the temperature range covered by the injection temperature and the composition's molten temperature as the composition fills the mold. As such, the injection temperature can be raised as part of raising the melt processing temperature. It is desirable to minimize premature crosslinking during this phase of the injection molding process.

The combination achieves a nominal induction time over the nominal melt processing temperature portion. At the nominal melt processing temperature, the expandable, crosslinkable polymeric composition achieves an improved induction time of at least 2-fold greater than the nominal induction time. Preferably, the improved induction time is at least 3-fold greater than the nominal induction time. More preferably, the improved induction time is at least 5-fold greater.

In yet another embodiment of the present invention, the invention is a process comprising the steps of (a) injecting at an injection temperature an expandable, crosslinkable polymeric composition into a mold at a mold temperature; (b) expanding the expandable, crosslinkable polymeric composition to an expanded, crosslinkable polymeric composition in the mold; and (c) crosslinking the expanded, crosslinkable polymeric composition to an expanded, crosslinked polymeric article in the mold.

In the present embodiment, the melt processing temperature would encompass the temperature range covered by the injection temperature and the composition's molten temperature as the composition fills the mold. As such, the injection temperature can be raised as part of raising the melt processing temperature. It is desirable to minimize premature crosslinking during this phase of the injection molding process.

The combination achieves a nominal induction time over the nominal melt processing temperature portion. At the nominal melt processing temperature, the expandable, crosslinkable polymeric composition achieves an improved induction time of at least 2-fold greater than the nominal induction time. Preferably, the improved induction time is at least 3-fold greater than the nominal induction time. More preferably, the improved induction time is at least 5-fold greater.

Preferably, after removal of the article of manufacture from the mold, the level of post-expansion is controlled such that post-expansion is less than about 1.5 volume percent change.

In a more preferred embodiment of the present invention, the invention is a process comprising the steps of (a) injecting at an injection temperature an expandable, crosslinkable polymeric composition into a mold at a mold temperature; (b) crosslinking the expandable, crosslinkable polymeric composition to the extent necessary to support a stable foam structure; (c) expanding the expandable, crosslinkable polymeric composition to an expanded, crosslinkable polymeric composition in the mold; and (d) further crosslinking the expanded, crosslinkable polymeric composition to an expanded, crosslinked polymeric article in the mold. In this preferred embodiment, it is particularly desirable to decouple the crosslinking reaction from the expansion of the polymeric composition.

The combination achieves a nominal induction time over the nominal melt processing temperature portion. At the nominal melt processing temperature, the expandable, crosslinkable polymeric composition achieves an improved induction time of at least 2-fold greater than the nominal induction time. Preferably, the improved induction time is at least 3-fold greater than the nominal induction time. More preferably, the improved induction time is at least 5-fold greater.

Preferably, after removal of the article of manufacture from the mold, the level of post-expansion is controlled such that post-expansion is less than about 1.5 volume percent change.

In yet another preferred embodiment, the present invention is a crosslinkable polymeric composition comprising a free-radical crosslinkable polymer and a crosslinking-temperature-profile modifier excluding 2,2,6,6,-tetramethyl piperidinyl oxy (TEMPO) and derivatives thereof.

In yet another preferred embodiment, the present invention is a free-radical crosslinkable polymer composition having excellent melt processing and physical properties. The invented composition comprises (1) a free-radical crosslinkable polymer or blend having poor melt processing properties at nominal melt processing temperatures and (2) a crosslinking-temperature-profile modifier. The crosslinking-temperature-profile modifier enables melt processing the free-radical crosslinkable polymer or blend at a temperature higher than the nominal melt processing temperature without premature crosslinking.

In particular, the present invention is useful with free-radical crosslinking polymers having a melting temperature equal to or greater than about 130 degrees Celsius. An example of a free-radical crosslinking polymer having a high melting temperature is high density polyethylene.

An example of a blend having improved melt processing characteristics is a blend of a linear low density polyethylene and a branched polyethylene, wherein at least one of the blended polymers in the absence of the crosslinking-temperature-profile modifier would be subject to premature crosslinking at nominal melt processing conditions. The addition of the crosslinking-temperature-profile modifier substantially suppresses the premature crosslinking, thereby permitting melt processing of the free-radical crosslinkable polymer composition. The presently invented composition permits the preparation of articles (from the free-radical crosslinkable polymeric composition) having excellent physical properties.

In yet another preferred embodiment, the present invention is an expandable, free-radical crosslinkable polymeric composition comprising a free-radical crosslinkable polymer, a free-radical inducing species, a crosslinking-temperature-profile modifier, and a blowing agent selected from the group consisting of chemical blowing agents and physical blowing agents.

In a preferred embodiment, the present invention is an article of manufacture prepared by an improved process of the present invention. The benefits of the present inventions are particularly apparent with thick articles of manufacture.

Any number of processes can be used to prepare the articles of manufacture. Specifically useful processes include injection molding, extrusion, injection blow molding, compression molding, rotational molding, thermoforming, blowmolding, powder coating, Banbury batch mixers, fiber spinning, rotational casting, compression transferring, laminating, and calendaring. Suitable articles of manufacture include power cable insulations (including insulations for extra high voltage (EHV), high voltage (HV), medium voltage (MV), and low voltage (LV) applications), wire-and-cable semiconductive articles (including semiconductive insulation shields), wire-and-cable coatings (including flame retardant automotive wire insulations) and jackets (including industrial cable jackets), cable accessories, shoe soles, multicomponent shoe soles (including polymers of different densities and type), weather stripping, gaskets, profiles, durable goods, rigid ultradrawn tape, run flat tire inserts, construction panels, composites (e.g., wood composites), pipes, foams, and fibers (including binder fibers and elastic fibers).

In another preferred embodiment, the present invention is an article of manufacture prepared from the new free-radical crosslinkable polymer compositions of the present invention. The article of manufacture can be a power cable accessory comprising a free-radical crosslinked polymer composition prepared from a composition comprising (a) a free-radical crosslinkable polymer selected from the group consisting of ethylene/propylene/diene monomers, ethylene/propylene rubbers, and mixtures thereof, in an amount between about 20 weight percent and about 90 weight percent, (b) a free-radical inducing species in an amount between about 0.5 weight percent and 10 weight percent, (c) a crosslinking-temperature profile modifier in an amount between about 0.1 weight percent and about 5 weight percent, and (d) inorganic fillers in an amount between about 10 weight percent and about 70 weight percent.

Another example of an article of manufacture is a power cable comprising a crosslinked insulation prepared from a free-radical crosslinkable polymer composition comprising (a) a free-radical crosslinkable polymer selected from the group consisting of ethylene/propylene/diene monomers, ethylene/propylene rubbers, and mixtures thereof, in an amount between about 20 weight percent and about 90 weight percent, (b) a free-radical inducing species in an amount between about 0.5 weight percent and 10 weight percent, (c) a crosslinking-temperature profile modifier in an amount between about 0.1 weight percent and about 5 weight percent, and (d) inorganic fillers in an amount between about 10 weight percent and about 70 weight percent. Another power cable of the present invention comprises a crosslinked, flame retardant insulation prepared from a free-radical crosslinkable polymer composition comprising (a) a free-radical crosslinkable polymer selected from the group consisting of ethylene/alpha-olefin copolymers, ethylene/unsaturated ester copolymers, and mixtures thereof, in an amount between about 10 weight percent and about 85 weight percent, (b) a free-radical inducing species in an amount between about 0.5 weight percent and 10 weight percent, (c) a crosslinking-temperature profile modifier in an amount between about 0.1 weight percent and about 5 weight percent, and (d) flame retardants in an amount between about 15 weight percent and about 70 weight percent.

An additional example of an article of manufacture is a power cable comprising a crosslinked, semiconductive insulation shield prepared from a free-radical crosslinkable polymer composition comprising (a) a free-radical crosslinkable polymer selected from the group consisting of ethylene/alpha-olefin copolymers, ethylene/unsaturated ester copolymers, and mixtures thereof, in an amount between about 10 weight percent and about 85 weight percent, (b) a free-radical inducing species in an amount between about 0.5 weight percent and 10 weight percent, (c) a crosslinking-temperature profile modifier in an amount between about 0.1 weight percent and about 5 weight percent, and (d) a conductive filler in amount sufficient to impart a volume resistivity of less than about 1000 Ohm-m. Preferably, the conductive filler will be present in an amount between about 20 weight percent and about 40 weight percent.

Another example is a power cable comprising a crosslinked insulation prepared from a free-radical crosslinkable polymer composition comprising (a) a free-radical crosslinkable polymer blend, comprising a linear low density polyethylene and a branched polyethylene, in an amount between about 20 weight percent and about 90 weight percent, (b) a free-radical inducing species in an amount between about 0.5 weight percent and 10 weight percent, (c) a crosslinking-temperature profile modifier in an amount between about 0.1 weight percent and about 5 weight percent, and (d) inorganic fillers in an amount between about 10 weight percent and about 70 weight percent. Yet another example is a power cable comprising a crosslinked jacket prepared from a free-radical crosslinkable polymer composition comprising (a) a free-radical crosslinkable polymer being chlorinated polyethylene and present in an amount between about 20 weight percent and about 90 weight percent, (b) a free-radical inducing species in an amount between about 0.5 weight percent and 10 weight percent, (c) a crosslinking-temperature profile modifier in an amount between about 0.1 weight percent and about 5 weight percent, and (d) inorganic fillers in an amount between about 10 weight percent and about 65 weight percent.

An example of a shoe sole article comprises an expanded, free-radical crosslinked polymer composition prepared from a composition comprising (a) a free-radical crosslinkable polymer being an ethylene/unsaturated ester copolymer in an amount between about 10 weight percent and about 85 weight percent, (b) a free-radical inducing species in an amount between about 0.5 weight percent and 10 weight percent, (c) a crosslinking-temperature profile modifier in an amount between about 0.01 weight percent and about 5 weight percent, and (d) a blowing agent selected from the group consisting of physical blowing agents and chemical blowing agents.

### EXAMPLES

The following non-limiting examples illustrate the invention.

### A Crosslinking-Temperature-Profile Modifier Exemplified

Comparative Example 1 and Example 2 were prepared with Affinity™ 8200 polyethylene, having a melt index of 5.0 grams per cubic centimeter and a density of 0.87 grams per cubic centimeter. Affinity™ 8200 polyethylene is available from The Dow Chemical Company.

Dicumyl peroxide (DiCup R), available from Geo Specialty Chemicals, was added to each composition in about 1.00 weight percent. The crosslinking-temperature-profile modifier was 4-hydroxy-TEMPO, commercially available from A. H. Marks. The 4-hydroxy-TEMPO was added to the Example 2 composition in about 0.20 weight percent. The remainder of each composition was the polyethylene resin. Both compositions were melt blended in a Brabender mixer.

For each evaluated composition, the MDR generated torque versus time data. At the set temperature, the MDR was set for a frequency of 100 cycles per minute and an arc of 0.5 degrees. For the test specimens of Comparative Example 1 and Example 2, the temperature was set at 140 degrees Celsius or 180 degrees Celsius. The particular set temperature and the resulting data are shown in Table I. The test specimens weighed about 5 grams and were placed between Mylar™ sheets and then into the MDR for evaluation. The set temperature and evaluation time were chosen based on the end-use application and the composition.

TABLE I

| | | |
|---|---|---|
| Property | Comparative Example 1 | Example 2 |

MDR: 140 degrees Celsius, 30 minutes

| | | |
|---|---|---|
| M_{L} (pound-inches) | 0.16 | 0.16 |
| TS 0.01 (minutes) | 1 | 7.5 |

MDR: 180 degrees Celsius, 30 minutes

| | | |
|---|---|---|
| M_{L} (pound-inches) | 0.84 | 1.09 |
| M_{H} (pound-inches) | 2.98 | 2.83 |
| t90 | 4.07 | 3.94 |

TS 0.01 —the time required to have a torque increase of 0.01 pounds-inch from the minimum torque
t90 —the time required to reach 90% of the ultimate cure level

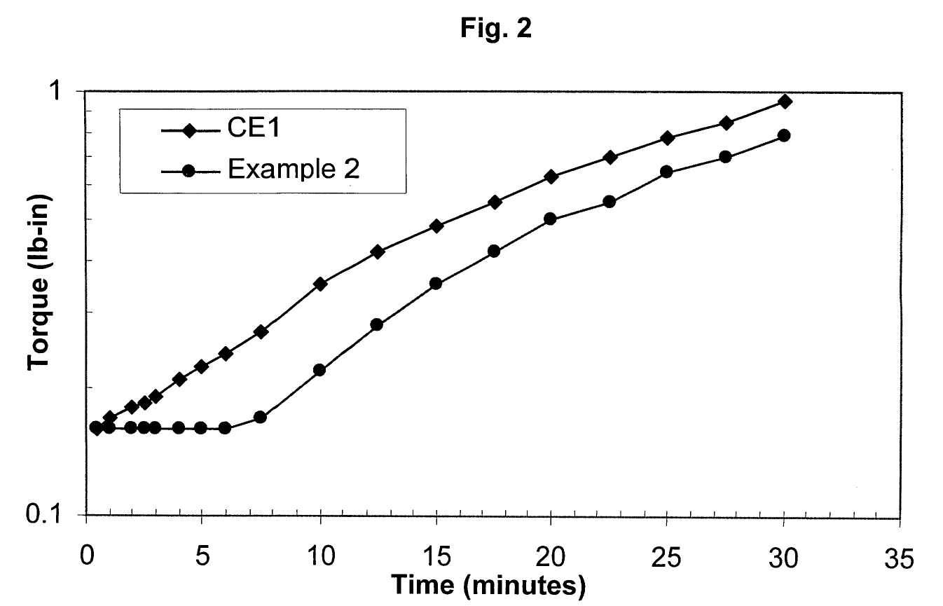

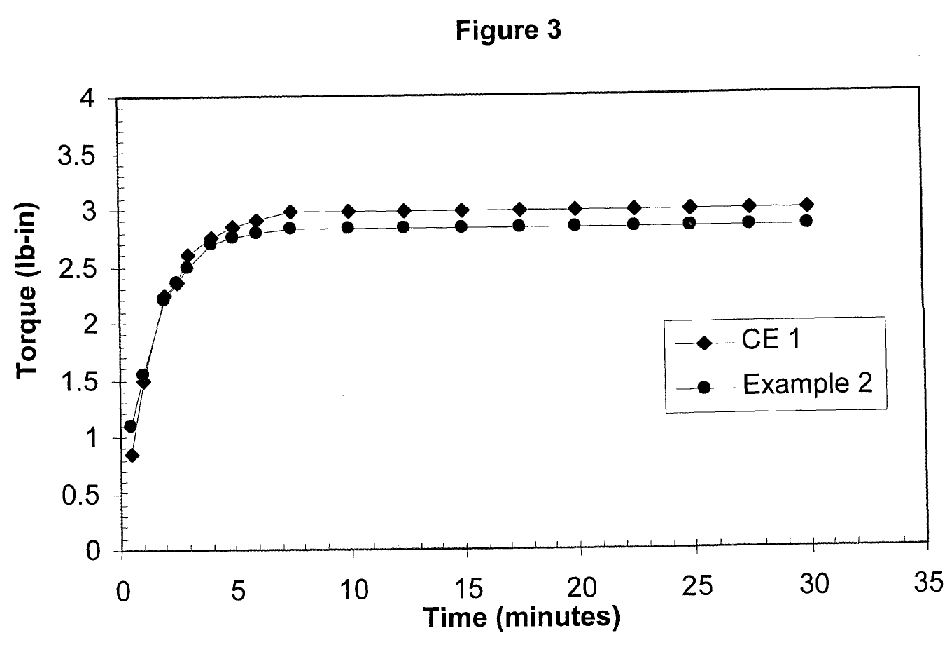

The TS 0.01 results show that the crosslinkable polymeric composition (containing a crosslinking-temperature-profile modifier) has a significantly longer scorch inhibition time than its comparative composition without the crosslinking-temperature-profile modifier. The t90 results indicate a similar cure rate between the crosslinkable polymeric composition and its comparative composition. See FIGS. 2 and 3.

### Crosslinking-Temperature-Profile Modifier in a Commercial Composition

Comparative Example 3 and Example 4 were prepared with SuperOhm™ 3728 peroxide-crosslinkable composition, which is a filled ethylene/propylene/diene monomer composition available from Schulman. The composition exemplifying the present invention contained about 0.25 weight percent of the crosslinking-temperature-profile modifier, 4-hydroxy-TEMPO. The remainder of each composition was the SuperOhm™ 3728 formulation. Both compositions were melt blended in a Brabender mixer.

TABLE II

| | | |
|---|---|---|
| Property | Comparative Example 3 | Example 4 |

MDR: 140 degrees Celsius, 30 minutes

| | | |
|---|---|---|
| M_{L} (pound-inches) | 1.13 | 1.03 |
| TS 0.01 (minutes) | <1 | 17 |
| TS 1 (minutes) | 14.4 | >30 |

MDR: 180 degrees Celsius, 30 minutes

| | | |
|---|---|---|
| M_{L} (pound-inches) | 0.76 | 0.78 |
| M_{H} (pound-inches) | 10.68 | 8.01 |
| t90 | 4.05 | 4.00 |

TS 1 - the time required to have a torque increase of 1 pounds-inch from the minimum torque

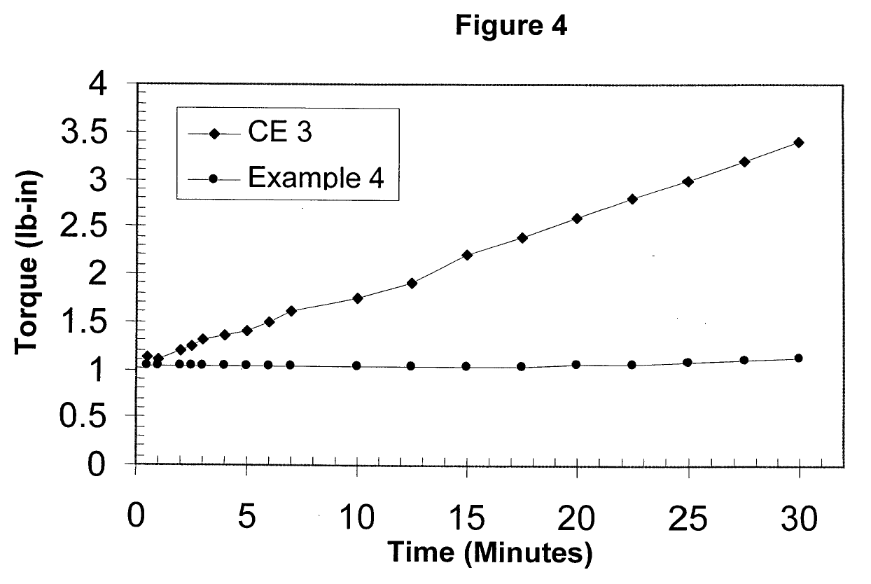

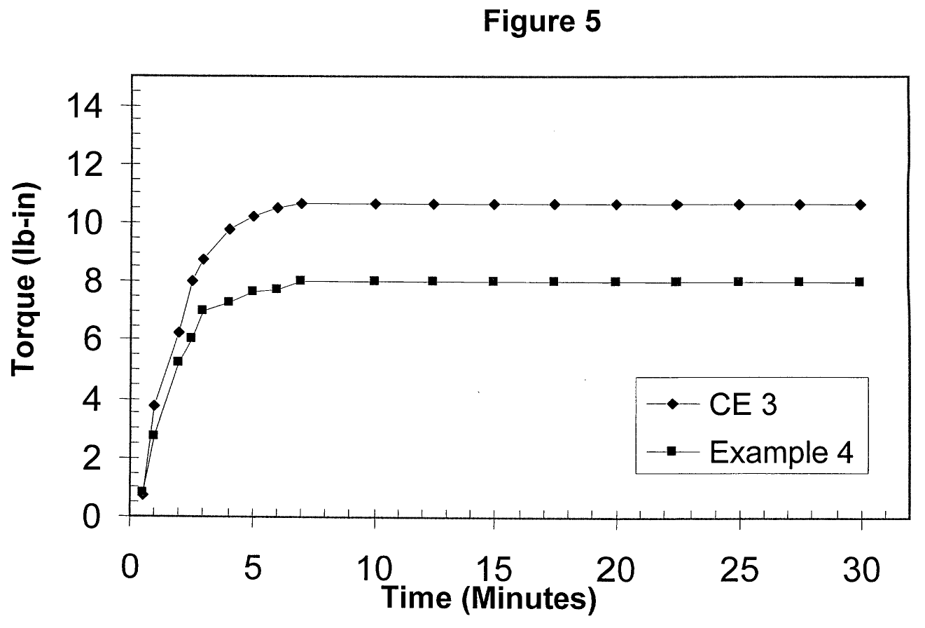

The TS 0.01 and TS 1 results show that the crosslinkable polymeric composition (containing a crosslinking-temperature-profile modifier) has a significantly longer scorch inhibition time than its comparative composition without the stable organic free radical. The t90 results indicate a similar cure rate between the crosslinkable polymeric composition and its comparative composition. See FIGS. 4 and 5.

### Impact of a Crosslinking-Temperature-Profile Modifier on a High Density Polyethylene

Comparative Examples 5 and 6 and Example 7 were prepared with DGDL-3364 high density polyethylene, which was commercially available from The Dow Chemical Company. Dicumyl peroxide (DiCup R) was added to Comparative Example 5 and Example 7 in about 1.00 weight percent. The crosslinking-temperature-profile modifier 4-hydroxy-TEMPO was added to the Example 7 composition in about 0.20 weight percent. The remainder of Comparative Example 5 and Example 7 was the high density polyethylene. Comparative Example 6 was only the high density polyethylene resin, without the crosslinking-temperature-profile modifier or peroxide added.

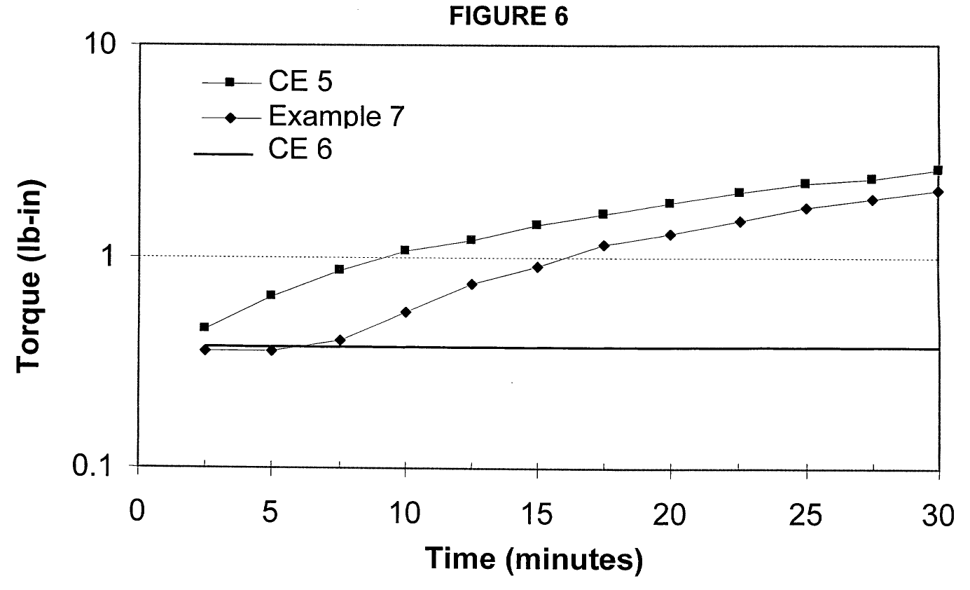

FIG. 6 shows the impact of the crosslinking-temperature-profile modifier on the onset of crosslinking at 150 degrees Celsius.

Comparative Examples 8, 9, 14, 15, 19, 21, 24, and 26 and Examples 10-13, 16-18, 20 22, 23, 25, and 27-Ethylene Polymers

A Brabender mixer was used to make 40 gram samples of the comparative examples and the examples described in this section. Generally, the components as listed in Table IV and V as weight percents were blended at 125° C. for 3 minutes. However, the components for Comparative Example 26 and Example 27 were blended at 135° C. because the resin had a relatively high viscosity and melting point.

Next, 1.7 weight percent of dicumyl peroxide (DiCup R) was added to each exemplified compositions. The compositions were compounded for another 4 minutes.

Dicumyl peroxide was available from Geo Specialty Chemicals Inc. The Irganox 1081 FF antioxidant and the crosslinking-temperature-profile modifier bis(1-oxyl-2,2,6,6-tetramethylpiperidine-4-yl)sebacate (the “bis-TEMPO”) were available from Ciba Specialty Chemicals Inc. The crosslinking-temperature-profile modifier 4-hydroxy-TEMPO was available from A. H. Marks. The Sartomer SR-350 trimethylolpropanetrimethacrylate was available from Sartomer Company, Inc.

The crosslinking kinetics of the blends was investigated using MDR at 140° C. (to simulate extrusion conditions where premature crosslinking is not desirable) and at 182° C. (to simulate vulcanization conditions in which rapid and effective crosslinking is desirable).

The following resins (see Table III) were used to prepare the exemplified compositions. Each of the resins was available from The Dow Chemical Company.

TABLE III

| | Melt In- | | | Melting |
|---|---|---|---|---|
| | dex, I2 | | Density | Point, |
| Resin | (dg/min) | I21/I2 | (g/cc) | Tm (° C.) |
| Mirathen CY 7423 LDPE | 2.1 | 53 | 0.9184 | 110.0 |
| DXM-446 LDPE | 2.4 | 52 | 0.9200 | 110.2 |
| LDPE 5101 | 1.9 | 43 | 0.9183 | 109.3 |
| Attane 4404G LLDPE | 4.4 | 30 | 0.9050 | 118.7 |
| Dowlex 2247G LLDPE | 2.3 | 26 | 0.9172 | 120.7 |
| Dowlex 3010 LLDPE | 5.3 | 28 | 0.9236 | 122.4 |
| DGDA-2490 NT 3408 HDPE | 0.07 | 83 | 0.9497 | 131.2 |

TABLE IV
63847A

| Component | C.E. 8 | C.E. 9 | Ex. 10 | Ex. 11 | Ex. 12 | Ex. 13 | C.E. 14 | C.E. 15 | Ex. 16 | Ex. 17 | Ex. 18 |
|---|---|---|---|---|---|---|---|---|---|---|---|
| Mirathen CY 7423 | 98.3 | 98.02 | 98.05 | 97.8 | 98.05 | 98.05 | | | | | |
| DXM-446 | | | | | | | 98.3 | 98.3 | 98.05 | 98.05 | 97.8 |
| Irganox 1081 FF | | 0.28 | | | | | | | | | |
| 4-hydroxy-TEMPO | | | 0.25 | 0.25 | | | | | 0.25 | | |
| Bis-TEMPO | | | | | 0.25 | 0.25 | | | | 0.25 | 0.5 |
| Sartomer SR-350 coagent | | | | 0.25 | | | | | | | |

MDR: 140 degrees Celsius/2 hours

| | | | | | | | | | | |
|---|---|---|---|---|---|---|---|---|---|---|
| Minimum Torque, M_{L} (lb-in) | 0.28 | 0.28 | 0.26 | 0.25 | 0.27 | 0.31 | 0.30 | 0.30 | 0.30 | 0.30 |
| Final Torque, M_{F} (lb-in) | 2.64 | 2.21 | 2.41 | 2.14 | 2.87 | 2.62 | 3.00 | 2.56 | 3.52 | 3.27 |
| M_{F}-M_{L} (lb-in) | 2.36 | 1.93 | 2.15 | 1.89 | 2.60 | 2.31 | 2.70 | 2.26 | 3.22 | 2.97 |
| Onset of Torque Increase | 2.00 | 3.00 | 15.00 | 15.00 | 4.00 | 2.00 | 4.00 | 19.00 | 6.00 | 9.00 |
| (minutes) | | | | | | | | | | |
| TS1 (minutes) | 38.78 | 58.64 | 49.48 | 54.32 | 35.78 | 33.43 | 28.69 | 48.34 | 25.93 | 35.89 |
| TS2 (minutes) | 90.73 | | 106.79 | | 77.61 | 85.76 | 115.27 | 96.13 | 78.53 | 94.51 |

MDR: 182 degrees Celsius/to completion (at least 12 minutes)

| | | | | | | | | | | | |
|---|---|---|---|---|---|---|---|---|---|---|---|
| Minimum Torque, M_{L} (lb-in) | 0.17 | 0.15 | 0.14 | 0.13 | 0.16 | 0.16 | 0.19 | 0.18 | 0.15 | 0.17 | 0.16 |
| Maximum Torque, M_{H} (lb-in) | 3.26 | 2.89 | 2.84 | 3.50 | 3.46 | 3.87 | 3.12 | 2.60 | 2.53 | 3.50 | 3.22 |
| M_{H}-M_{L} (lb-in) | 3.09 | 2.74 | 2.70 | 3.37 | 3.30 | 3.71 | 2.93 | 2.42 | 2.38 | 3.33 | 3.06 |
| Onset of Torque Increase | 0.50 | 0.65 | 0.70 | 0.70 | 0.55 | 0.50 | 0.40 | | 0.60 | | |
| (minutes) | | | | | | | | | | | |
| TS1 (minutes) | 1.47 | 1.75 | 1.70 | 1.47 | 1.36 | 1.24 | 1.22 | 1.51 | 1.55 | 1.23 | 1.29 |
| TS2 (minutes) | 2.75 | 3.42 | 3.33 | 2.44 | 2.38 | 2.07 | 2.14 | 3.10 | 3.24 | 1.93 | 2.06 |
| t10 (minutes) | 0.88 | 0.99 | 0.99 | 0.98 | 0.86 | 0.84 | 0.77 | 0.90 | 0.89 | 0.87 | 0.89 |
| t50 (minutes) | 2.07 | 2.21 | 2.11 | 2.07 | 1.96 | 1.93 | 1.57 | 1.72 | 1.75 | 1.65 | 1.64 |
| t90 (minutes) | 5.34 | 5.40 | 5.12 | 5.09 | 4.97 | 4.99 | 3.60 | 3.82 | 3.84 | 3.60 | 3.47 |

Gel content (percent)

| | | | | | | | | | |
|---|---|---|---|---|---|---|---|---|---|
| 63.68 | 81.24 | 67.18 | 84.09 | 85.76 | 61.72 | 77.84 | 76.13 | 83.75 | 80.09 |

TABLE V
63847A

| Component | C.E. 19 | Ex. 20 | C.E. 21 | Ex. 22 | Ex. 23 | C.E. 24 | Ex. 25 | C.E. 26 | Ex. 27 |
|---|---|---|---|---|---|---|---|---|---|
| Attane 4404G | 98.3 | 98.05 | | | | | | | |
| Dowlex 2247G | | | 98.3 | 98.05 | 98.05 | | | | |
| Dowlex 3010 | | | | | | 98.3 | 98.05 | | |
| DGDA-2490 NT | | | | | | | | 98.3 | 98.05 |
| 4-hydroxy-TEMPO | | 0.25 | | 0.25 | 0.25 | | 0.25 | | 0.25 |

MDR: 140 degrees Celsius/2 hours

| | | | | | | | | | |
|---|---|---|---|---|---|---|---|---|---|
| Minimum Torque, M_{L} (lb-in) | 0.16 | 0.16 | 0.23 | 0.23 | 0.21 | 0.11 | 0.11 | 0.73 | 0.80 |
| Final Torque, M_{F} (lb-in) | 7.42 | 6.01 | 7.86 | 7.43 | 6.96 | 6.47 | 4.40 | 3.05 | 3.52 |
| M_{F}-M_{L} (lb-in) | 7.26 | 5.85 | 7.63 | 7.20 | 6.75 | 6.36 | 4.29 | 2.32 | 2.72 |
| Onset of Torque Increase (minutes) | 1.00 | 12.00 | 1.00 | 17.00 | 20.00 | 1.00 | 20.00 | 2.00 | 12.00 |
| TS1 (minutes) | 8.51 | 26.11 | 9.98 | 30.24 | 32.96 | 8.78 | 36.17 | 18.94 | 36.26 |
| TS2 (minutes) | 19.16 | 35.19 | 21.28 | 37.99 | 47.41 | 21.81 | 50.28 | 70.88 | 113.01 |

MDR: 182 degrees Celsius/to completion (at least 12 minutes)

| | | | | | | | | | |
|---|---|---|---|---|---|---|---|---|---|
| Minimum Torque, M_{L} (lb-in) | 0.15 | 0.08 | 0.16 | 0.14 | 0.15 | 0.13 | 0.06 | 0.81 | 0.64 |
| Maximum Torque, M_{H} (lb-in) | 6.93 | 6.94 | 10.26 | 10.72 | 9.52 | 7.25 | 6.60 | 6.54 | 7.19 |
| M_{H}-M_{L} (lb-in) | 6.78 | 6.86 | 10.10 | 10.58 | 9.37 | 7.12 | 6.54 | 5.73 | 6.55 |
| Onset of Torque Increase (minutes) | 0.40 | 0.40 | 0.30 | 0.60 | 0.70 | 0.40 | 0.60 | 0.70 | 0.70 |
| TS1 (minutes) | 0.74 | 0.90 | 0.66 | 0.94 | 1.05 | 0.74 | 1.05 | 0.97 | 1.23 |
| TS2 (minutes) | 0.95 | 1.11 | 0.79 | 1.07 | 1.22 | 0.93 | 1.33 | 1.15 | 1.46 |
| t10 (minutes) | 0.67 | 0.83 | 0.66 | 0.94 | 1.04 | 0.68 | 0.94 | 0.90 | 1.11 |
| t50 (minutes) | 1.32 | 1.47 | 1.28 | 1.61 | 1.80 | 1.31 | 1.81 | 1.35 | 1.84 |
| t90 (minutes) | 3.22 | 3.23 | 3.78 | 4.29 | 4.33 | 3.27 | 4.64 | 3.11 | 4.60 |

Gel content (percent)

| | | | | | | | |
|---|---|---|---|---|---|---|---|
| 84.68 | 74.23 | 93.10 | 70.12 | 87.15 | 86.64 | 70.17 | 69.23 |

### Polyethylene Insulation Example 28 and Comparative Example 29

An example and a comparative example were prepared with a polyethylene-based insulation composition and DiCup R organic peroxide. The composition exemplifying the present invention also contained 4-hydroxy-TEMPO.

The polyethylene composition was the peroxide-containing HFDB-4202 tree retardant insulation composition, commercially available from The Dow Chemical Company. The dicumyl peroxide (DiCup R) was an organic peroxide and commercially available from Geo Specialty Chemicals. The 4-hydroxy-TEMPO was commercially available from A. H. Marks.

The amounts used to prepare Example 28 and Comparative Example 29 are shown in Table VI as weight percents.

TABLE VI

| Component | Example 28 | Comparative Example 29 |
|---|---|---|
| insulation composition | 99.35 | 100.00 |
| DiCup R | 0.25 | |
| 4-hydroxy-TEMPO | 0.40 | |

The crosslinking kinetics of Example 28 and Comparative Example 29 were investigated using MDR at 140 degrees Celsius and 150 degrees Celsius (to simulate melt processing conditions where premature crosslinking is not desirable) and at 182 degrees Celsius (to simulate crosslinking conditions in which rapid and effective crosslinking is desirable). At 140 and 150 degrees Celsius, longer induction times are preferable. At 182 degrees Celsius, shorter times to the desired torque are preferable, particularly when accompanied by high crosslinking densities (or higher ultimate torque).

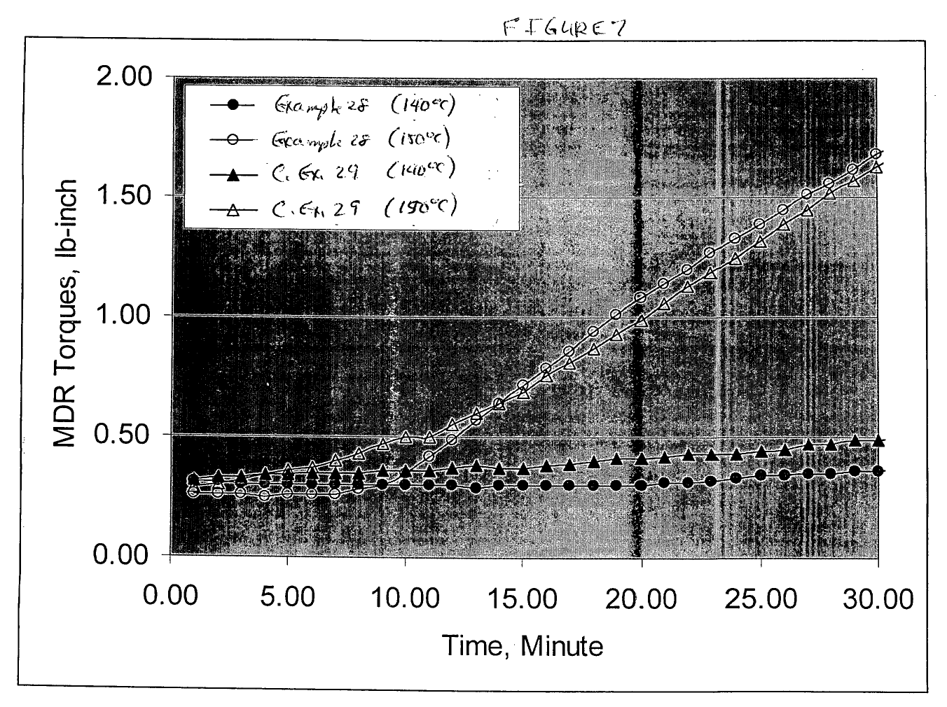

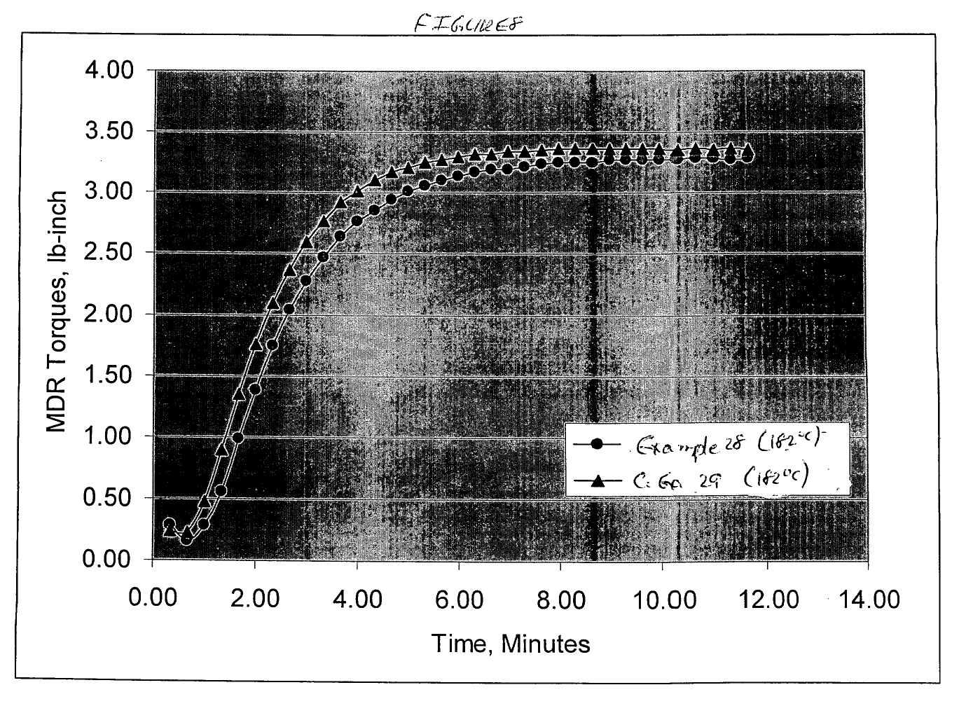

FIG. 7 showed torque-time curves at 140 degrees Celsius and at 150 degrees Celsius. FIG. 8 showed the torque-time curves at 182 degrees Celsius.

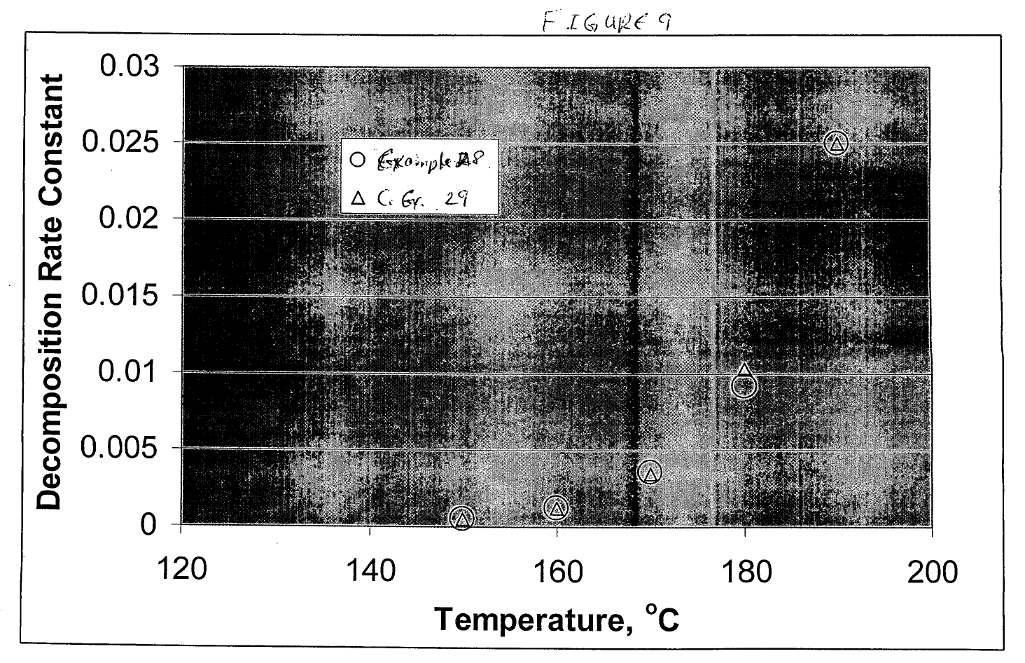

The crosslinking kinetics of Example 28 and Comparative Example 29 were also investigated using MDR over the temperature range of 150 to 190 degrees Celsius to determine the rates of peroxide decomposition. The percent peroxide decomposition was calculated at each temperature and are shown in FIG. 9. FIG. 9 indicates that the exemplified composition can achieve decomposition rates equivalent to those of the comparative composition and thereby provide an adequate rate of crosslinking.

Example 28 and Comparative Example 29 were processed through a 2.5 inch Davis standard extruder. The resultant extrudated strand was evaluated as to its quality. A “clean” strand did not exemplify premature crosslinking. A “failed” strand exemplified premature crosslinking. Table VII shows the process condition for the melt processing (Melt Temp.) of the extrudated strand. All temperatures are reported in degrees Celsius and screw speeds are reported in revolutions per minute (RPM). Comparable throughput rates were achieved between the compositions at the same melt temperatures and screw speeds.

TABLE VII

| Example | Melt Temp. | Screw Speed | Strand Quality |
|---|---|---|---|
| Ex. 11 | 140 | 5 | Clean |
| C. Ex. 12 | 140 | 5 | Clean |
| Ex. 11 | 140 | 15 | Clean |
| C. Ex. 12 | 140 | 15 | Clean |
| Ex. 11 | 140 | 25 | Clean |
| C. Ex. 12 | 140 | 25 | Clean |
| Ex. 11 | 150 | 5 | Clean |
| C. Ex. 12 | 150 | 5 | Failed |
| Ex. 11 | 150 | 30 | Clean |
| C. Ex. 12 | 150 | 30 | Failed |

### Comparative Example 30 and Examples 31-35

Each of Comparative Example 30 and Examples 31-35 used a standard crosslinkable polymeric composition, which contains a peroxide. To each Example composition, 0.28 weight percent of the crosslinking-temperature-profile modifier 4-hydroxy-TEMPO was added.

The 4-hydroxy TEMPO was commercially available from A. H. Marks. The allyl pentaerythritol (or pentaerythritol triacrylate or triallyl pentaerythritol) was available from Perstorp. The 2,4-diphenyl-4-methyl-1-pentene was available from Aldrich. The Sartomer SR 350 trimethylolpropanetrimethacrylate and Sartomer SR 507 triallyl cyanurate were available from Sartomer Company, Inc.

TABLE VIII

| | C.E. | Ex. | Ex. | Ex. | Ex. | Ex. |
|---|---|---|---|---|---|---|
| Component | 30 | 31 | 32 | 33 | 34 | 35 |
| polymeric composition | 100 | 99.72 | 99.44 | 99.44 | 99.44 | 99.44 |
| 4-hydroxy-TEMPO | | 0.28 | 0.28 | 0.28 | 0.28 | 0.28 |
| allyl pentaerythritol | | | 0.28 | | | |
| 2,4-diphenyl-4- | | | | 0.28 | | |
| methyl-1-pentene | | | | | | |
| Sartomer SR 350 | | | | | 0.28 | |
| Sartomer SR 507 | | | | | | 0.28 |

MDR: 140 degrees Celsius for 30 minutes

| | | | | | | |
|---|---|---|---|---|---|---|
| TS1 (min) | 6.31 | 18.2 | 17.74 | 18.09 | 18.48 | 17.92 |

MDR: 177 degrees Celsius for 12 minutes

| | | | | | | |
|---|---|---|---|---|---|---|
| M_{L} (lb-in) | 2.34 | 2.27 | 2.26 | 2.23 | 2.24 | 2.26 |
| M_{H} (lb-in) | 15.81 | 14.39 | 14.3 | 13.68 | 15.42 | 14.44 |
| TS1 (min) | 0.44 | 0.76 | 0.77 | 0.84 | 0.79 | 0.8 |
| TS2 (min) | 0.62 | 0.97 | 0.98 | 1.06 | 1.01 | 1.02 |
| t10 (min) | 0.48 | 0.79 | 0.8 | 0.87 | 0.83 | 0.83 |
| t50 (min) | 1.16 | 1.51 | 1.51 | 1.55 | 1.73 | 1.55 |
| t90 (min) | 3.11 | 3.61 | 3.55 | 3.58 | 4.17 | 3.65 |
| Cure rate index: | 40.2 | 37.9 | 38.9 | 39.7 | 31.6 | 38.0 |
| 100/(t90-TS2) | | | | | | |

### Examples 36-38 (Effect of High Melting Stabilizer)

Each of Examples 36-38 was prepared with Nordel™ 3722P ethylene/propylene/diene monomer pellets, 6.0 weight percent of the crosslinking-temperature-profile modifier 4-hydroxy-TEMPO, and 1.00 weight percent of DFDB-5410 BK. The amount of the ethylene/propylene/diene monomer pellets and the remaining components are specified in Table VII. The EPDM pellets contained a peroxide.

Nordel™ 3722P ethylene/propylene/diene monomer (EPDM) had <1% diene and a Mooney Viscosity of 20 at 125 degrees Celsius. It was commercially available from DuPont Dow Elastomers L.L.C. The 4-hydroxy-TEMPO was commercially available from A. H. Marks. The DFDB-5410 BK was a color masterbatch and commercially available from The Dow Chemical Company. The Sartomer SR 350 trimethylolpropanetrimethacrylate were available from Sartomer Company, Inc. The zinc stearate was commercially available from Baerlocher. All compositions were melt blended in a Brabender mixer.

TABLE IX

| Component | Example 36 | Example 37 | Example 38 |
|---|---|---|---|
| Nordel IP 3722 | 93.00 | 89.00 | 87.00 |
| Sartomer SR 350 | | | 2.00 |
| Zinc Stearate | | 4.00 | 4.00 |

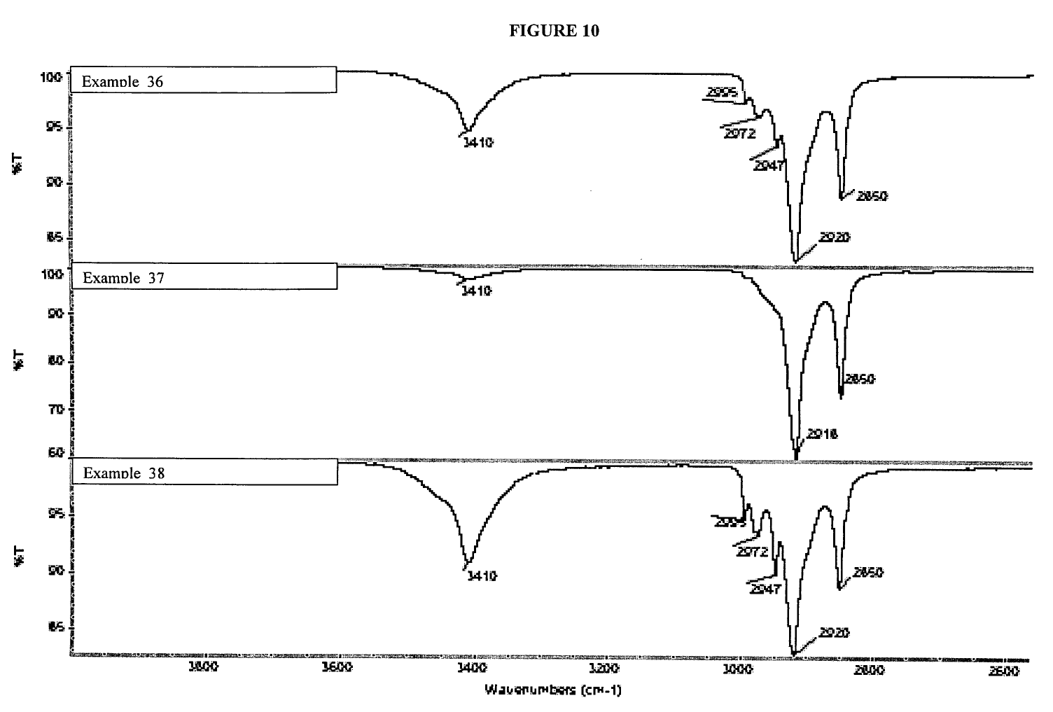

The surfaces of the samples were analyzed by Attenuated Total Reflectance (ATR) infrared. The spectra were collected at several different areas of the same sample. The results showed that the least amount of 4-hydroxy-TEMPO was detected on surface of Example 37 while the highest amount was found on Example 38. See FIG. 10, which is a plot of ATR results.

### EPDM/Modifier Masterbatch A

A EPDM/Modifier Masterbatch A containing a crosslinking temperature-profile modifier was prepared with Nordel™ 3722P ethylene/propylene/diene monomer pellets, zinc stearate, DFDB-5410 BK, and 4-hydroxy-TEMPO. Nordel™ 3722P ethylene/propylene/diene monomer (EPDM) had <1% diene and a Mooney Viscosity of 20 at 125 degrees Celsius. It was commercially available from DuPont Dow Elastomers L.L.C.

The zinc stearate was commercially available from Baerlocher. The DFDB-5410 BK was a color masterbatch and commercially available from The Dow 20 Chemical Company. The 4-hydroxy-TEMPO was commercially available from A. H. Marks. All components were melt blended in a Banbury mixer.

The amounts used to prepare the EPDM/Modifier Masterbatch A are shown in Table X as weight percents.

TABLE X

| Component | EPDM/Modifier Masterbatch A |
|---|---|
| Nordel ™ 3722P EPDM pellets | 90.00 |
| Zinc stearate | 4.00 |
| DFDB-5410 BK | 1.00 |
| 4-hydroxy-TEMPO | 5.00 |

### Peroxide/EPDM Masterbatch B

A peroxide-containing crosslinkable polymer was prepared as a masterbatch. The amounts used to prepare the Peroxide/EPDM Masterbatch B are shown in Table XI as weight percents.

TABLE XI

| | Peroxide/EPDM |
|---|---|
| Components | Masterbatch B |
| EPDM | 45.0 |
| Treated calcined clay | 35.5 |
| Carbon black masterbatch | 1.5 |
| Zinc stearate | 0.5 |
| Polymerized 1,2-dihydro-2,2,4-trimethylquinoline | 0.5 |
| White mineral oil | 12.5 |
| Red lead | 1.7 |
| Varox ™ DCP 40KE dicumyl peroxide | 2.7 |
| Sulfur, fine particles | 0.1 |

The EPDM consisted of an EPDM or a blend of EPDMs, having ≈5% diene content and ≈40 Mooney viscosity at 125 degrees Celsius. The EPDM(s) were commercially available from DuPont Dow Elastomers L.L.C.

The treated calcined clay was commercially available from Engelhard. The zinc stearate was commercially available from Baerlocher. The polymerized 1,2-dihydro-2,2,4-trimethylquinoline was commercially available from R.T. Vanderbilt Company. The white mineral oil was commercially available from Citgo. The red lead was commercially available from Rhein Chemie Rubber. Varox™ DCP 40KE dicumyl peroxide was a cure accelerator and commercially available from Geo Specialty Chemicals. The sulfur was commercially available from Rhein Chemie Rubber.

### Example 39 and Comparative Example 40

A quantity of the EPDM/Modifier Masterbatch A was added to a quantity of Peroxide/EPDM Masterbatch B to prepare a free-radical crosslinkable polymer composition for use in the present invention, Example 39. Example 39 was compared to a quantity of Peroxide/EPDM Masterbatch B in the absence of the crosslinking temperature profile modifier, Comparative Example 40.

Varox™ DCP 40KE dicumyl peroxide is a cure accelerator and commercially available from Geo Specialty Chemicals.

The amounts used to prepare Example 39 and Comparative Example 40 are shown in Table XII as weight percents. All components for each composition were melt blended in a Banbury mixer.

TABLE XII

| | | Comparative |
|---|---|---|
| Component | Example 39 | Example 40 |
| Peroxide/EPDM Masterbatch B | 94.89 | 100.00 |
| EPDM/Modifier Masterbatch A | 5.00 | |
| Varox DCP 40KE dicumyl peroxide | 0.11 | |

Example 39 and Comparative Example 40 were processed to make injection molded articles. Table XIII shows the process condition for the melt processing temperature (Melt Temp.) and crosslinking temperature (Cure Temp.) the molded articles. All temperatures are reported in degrees Celsius. All times are reported in minutes.

The appearance of the parts is reported in the column labeled “Part.” When the exemplified composition and process conditions were not conducive to making a part, the Part column identifies “NP” for cannot make parts and “Scorch” when the composition prematurely crosslinked.

TABLE XIII

| | Melt | Cure | Melt | Cure | Cycle | |
|---|---|---|---|---|---|---|
| Example | Temp. | Temp. | Time | Time | Time | Part |
| Ex. 39 | 121 | 168 | 1.5 | 14 | 15.5 | Good |
| Ex. 39 | 121 | 185 | 1.5 | 10 | 11.5 | Good |
| C. Ex. 40 | 93 | 168 | 3 | 17 | 20.0 | Good |

### EPDM/Modifier Masterbatch C

An EPDM/Modifier Masterbatch C containing a crosslinking temperature-profile modifier was prepared with Nordel™ 3722P ethylene/propylene/diene monomer pellets, Nipol™ DP-5161 nitrile rubber, 4-hydroxy-TEMPO, and dicumyl peroxide. Nordel™ 3722P ethylene/propylene/diene monomer (EPDM) had <1% diene and a Mooney Viscosity of 20 at 125 degrees Celsius. It was commercially available from DuPont Dow Elastomers L.L.C.

Nipol™ DP-5161 nitrile rubber was commercially available from Zeon Chemicals. The 4-hydroxy-TEMPO was commercially available from A. H. Marks. The dicumyl peroxide (DiCup R) was a cure accelerator and commercially available from Geo Specialty Chemicals.

The amounts used to prepare the EPDM/Modifier Masterbatch C are shown in Table XIV as weight percents. All components were melt blended in a Brabender mixer.

TABLE XIV

| Component | EPDM/Modifier Masterbatch C |
|---|---|
| Nordel ™ 3722P EPDM pellets | 44.60 |
| Nipol ™ DP-5161 nitrile rubber | 45.00 |
| 4-hydroxy-TEMPO | 6.00 |
| dicumyl peroxide | 4.40 |

### EPDM Masterbatch D

A crosslinkable polymer was prepared as a masterbatch. The amount used to prepare the EPDM Masterbatch D are shown in Table VI as weight percents. All components were melt blended in a Brabender mixer.

TABLE XV

| Components | EPDM Masterbatch D |
|---|---|
| EPDM | 46.0 |
| Treated calcined clay | 36.8 |
| Carbon black masterbatch | 1.5 |
| Zinc stearate | 0.5 |
| Polymerized 1,2-dihydro-2,2,4-trimethylquinoline | 0.5 |
| White mineral oil | 12.9 |
| Red lead | 1.8 |
| Sulfur, fine particles | 0.1 |

The EPDM consisted of an EPDM or a blend of EPDMs, having 5% diene content and ≈40 Mooney viscosity at 125 degrees Celsius. The EPDM(s) were commercially available from DuPont Dow Elastomers L.L.C.

The treated calcined clay was commercially available from Engelhard. The zinc stearate was commercially available from Baerlocher. The polymerized 1,2-dihydro-2,2,4-trimethylquinoline was commercially available from R.T. Vanderbilt Company. The white mineral oil was commercially available from Citgo. The red lead was commercially available from Rhein Chemie Rubber. The sulfur was commercially available from Rhein Chemie Rubber.

### Example 41 and Comparative Example 42

A quantity of the EPDM/Modifier Masterbatch C was added to a quantity of EPDM Masterbatch D to prepare a free-radical crosslinkable polymer composition for use in the present invention, Example 41. Example 41 was compared to a quantity of EPDM Masterbatch B in the absence of the crosslinking temperature profile modifier, Comparative Example 42.

The amounts used to prepare Example 41 and Comparative Example 42 are shown in Table XVI as weight percents. All components for each composition were melt blended in a Banbury mixer.

TABLE XVI

| Component | Example 41 | Comparative Example 42 |
|---|---|---|
| EPDM Masterbatch D | 95.00 | 100.00 |
| EPDM/Modifier Masterbatch C | 5.00 | |

The crosslinking kinetics of Example 41 and Comparative Example 42 were investigated using Moving Die Rheometer (MDR) at 140 degrees Celsius (to simulate melt processing conditions where premature crosslinking is not desirable) and at 177 degrees Celsius (to simulate crosslinking conditions in which rapid and effective crosslinking is desirable). At 140 degrees Celsius, longer induction times are preferable. At 177 degrees Celsius, shorter times to the desired torque are preferable, particularly when accompanied by high crosslinking densities (or higher ultimate torque).

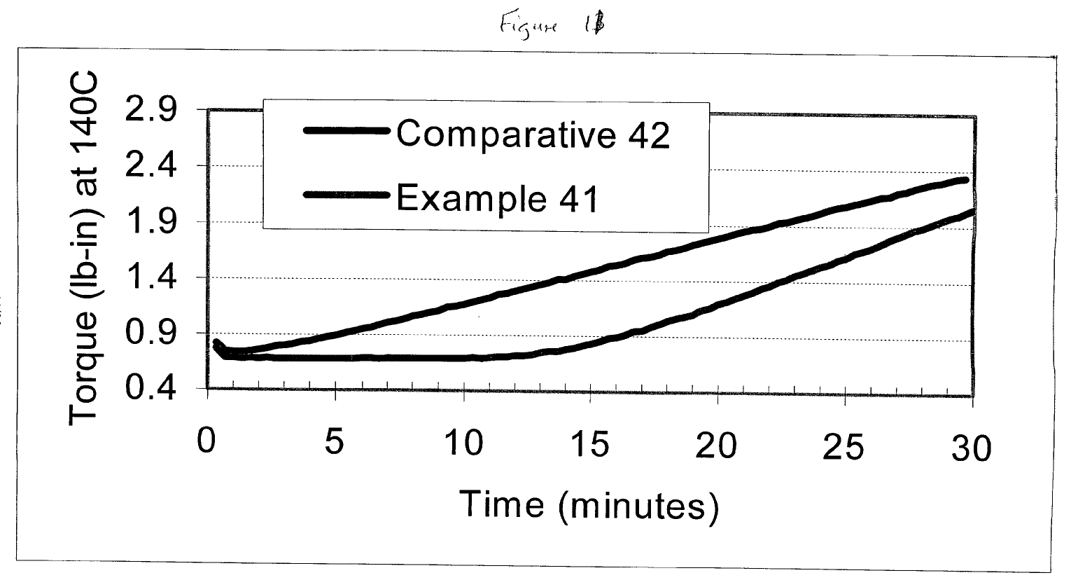

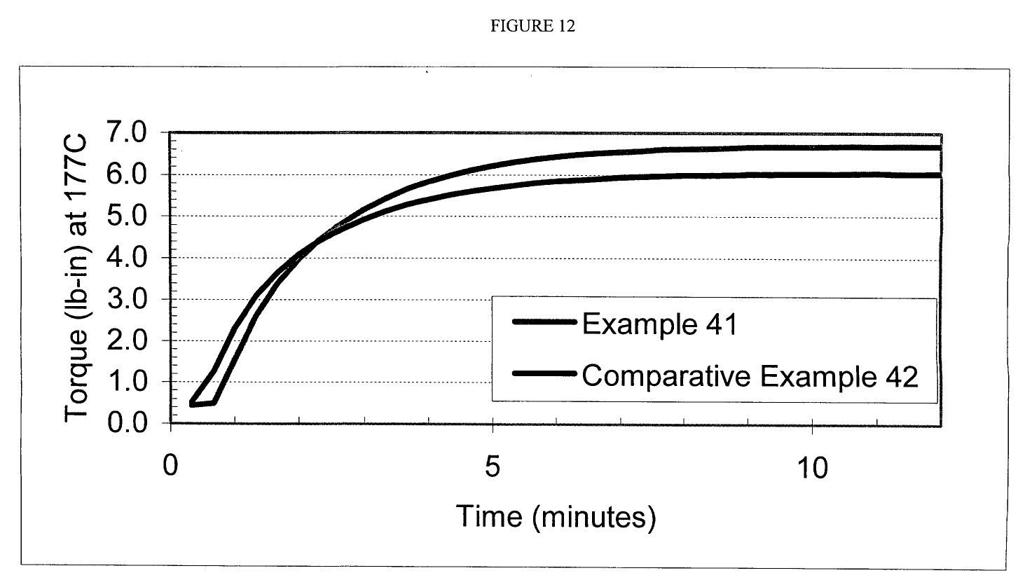

FIG. 11 showed torque-time curves at 140 degrees Celsius while FIG. 12 showed the torque-time curves at 177 degrees Celsius.

### EPDM Example 43 and Comparative Example 44

An EPDM example and comparative example were prepared with Nordel™ 3722P ethylene/propylene/diene monomer pellets, a low density polyethylene, Kadox 930C zinc oxide, Translink 37 treated, calcined clay, Astor 4412 paraffin wax, Agerite MA antioxidant, dicumyl peroxide, and DFDB-5410 BK color masterbatch. The EPDM Example 5 also contained 4-hydroxy-TEMPO.

Nordel™ 3722P ethylene/propylene/diene monomer (EPDM) had <1% diene and a Mooney Viscosity of 20 at 125 degrees Celsius. It was commercially available from DuPont Dow Elastomers L.L.C. The low density polyethylene had a melt index of 2 g/10 minutes and a density of 0.923 grams per cubic centimeter.

Kadox 930C zinc oxide was commercially available from Zinc Corporation of America. Translink 37 treated, calcined clay was commercially available from Engelhard. Astor 4412 paraffin wax was commercially available from Honeywell. Agerite MA antioxidant was commercially available from R. T. Vanderbilt Company. DFDB-5410 BK color masterbatch was commercially available from The Dow Chemical Company. The dicumyl peroxide (DiCup R) was an organic peroxide and commercially available from Geo Specialty Chemicals. The 4-hydroxy-TEMPO was commercially available from A. H. Marks.

The amounts used to prepare Example 43 and Comparative Example 44 are shown in Table XVII as weight percents. All components for each composition were melt blended in a Banbury mixer.

TABLE XVII

| Components | Example 43 | Comparative Example 44 |
|---|---|---|
| EPDM | 55.81 | 56.05 |
| LDPE | 2.71 | 2.72 |
| zinc oxide | 2.71 | 2.72 |
| treated, calcined clay | 32.61 | 32.61 |
| paraffin wax | 2.71 | 2.72 |
| antioxidant | 0.82 | 0.82 |
| peroxide | 1.36 | 1.36 |
| color masterbatch | 1.00 | 1.00 |
| 4-hydroxy-TEMPO | 0.27 | |

Example 43 and Comparative Example 44 were processed to make injection molded articles. Table XVIII shows the process condition for the melt processing temperature (Melt Temp.) and crosslinking temperature (Cure Temp.) for the molded articles. All temperatures are reported in degrees Celsius. All Cure Times are reported in seconds.

The appearance of the parts is reported in the column labeled “Part.” When the exemplified composition and process conditions were not conducive to making a part, the Part column identifies “NP” for cannot make parts and “Scorch” when the composition prematurely crosslinked.

TABLE XVIII

| | | Cure | | Gel Content | |
|---|---|---|---|---|---|
| Example | Melt Temp. | Temp. | Cure Time | (%) | Part |
| C. Ex. 44 | 120 | 165 | 140 | >90% | Good |
| C. Ex. 44 | 120 | 165 | 120 | | NP |
| C. Ex. 44 | 135 | 165 | 200 | | Scorch |
| Ex. 43 | 150 | 165 | 140 | >90% | Good |
| Ex. 43 | 150 | 180 | 45 | >89% | Good |

### EPDM Example 45 and Comparative Example 46

A peroxide-crosslinkable EPDM example and comparative example were prepared with Nordel™ NDR 3722P ethylene/propylene/diene monomer pellets, CSX-614 carbon black, SUNPAR 2280 processing oil, and Dicup R organic peroxide. The peroxide-crosslinkable EPDM Example 45 also contained 4-hydroxy-TEMPO.

Nordel™ NDR 3722P ethylene/propylene/diene monomer (EPDM) had <1% diene and a Mooney Viscosity of 20 at 125 degrees Celsius. It was commercially available from DuPont Dow Elastomers L.L.C. The CSX-614 carbon black was commercially available from Cabot Corporation. The SUNPAR™ 2280 had a viscosity of 475 centistokes at 40 degrees Celsius and was commercially available from Sunoco. The 4-hydroxy-TEMPO was commercially available from A. H. Marks. The dicumyl peroxide (DiCup R) was a cure accelerator and commercially available from Geo Specialty Chemicals.

The amounts used to prepare Example 45 and Comparative Example 46 are shown in Table XIX as weight percents. All components for each composition were melt blended in a Brabender mixer.

TABLE XIX

| Component | Example 45 | Comparative Example 46 |
|---|---|---|
| EPDM | 61.4 | 62.1 |
| Carbon black | 29.9 | 29.9 |
| Processing oil | 6.0 | 6.0 |
| Organic peroxide | 2.5 | 2.0 |
| 4-hydroxy-TEMPO | 0.2 | 0 |

Example 45 and Comparative Example 46 were processed to make extruded articles. Table XX shows the processing condition for the melt processing (melt temperature) of the extruded articles. All temperatures are reported in degrees Celsius. All screw speeds are reported in revolutions per minute (rpm), and all pressures are reported in pounds per square-inch (psi).

The surface quality of the parts is reported in the column labeled “Surface”. A “rough” surface is indicative of premature crosslinking.

TABLE XX

| Example | Melt Temp. | Pressure | Screw Speed | Surface |
|---|---|---|---|---|
| Ex. 45 | 120 | 194 | 5 | smooth |
| Ex. 45 | 126 | 209 | 5 | smooth |
| Ex. 45 | 130 | 252 | 5 | smooth |
| Ex. 45 | 120 | 284 | 10 | smooth |
| Ex. 45 | 127 | 261 | 10 | smooth |
| C. Ex. 46 | 114 | 222 | 5 | rough |
| C. Ex. 46 | 122 | 242 | 5 | rough |
| C. Ex. 46 | 127 | 321 | 5 | rough |

### Examples 47-51—Ethylene/Vinylacetate Copolymer Formulations

Each of Examples 47-51 used Elvax™ 460 ethylene/vinyl acetate copolymer in standard injection molding formulations. The formulations contained 3 weight percent of Perkadox™ 1440 bis (t-butyl peroxy) diisopropylbenzene, 5 weight percent of Omyalite™ 95T calcium carbonate, 0.1 weight percent of zinc stearate, 0.1 weight percent of Irganox™ B225 blended antioxidants, and a different amount of the crosslinking-temperature-profile modifier 4-hydroxy-TEMPO. The amounts of 4-hydroxy-TEMPO are shown in Table XXI.

Elvax™ 460 ethylene/vinyl acetate copolymer contained 18 percent vinyl acetate by weight and had a melt index of 2.5 grams per 10 minutes. The EVA was commercially available from DuPont.

The Perkadox™ 1440 bis (t-butyl peroxy) diisopropylbenzene was commercially available from Akzo Nobel. The Omyalite™ 95T calcium carbonate was commercially available from Omya. The zinc stearate was commercially available from Baerlocher. The Irganox™ B225 blended antioxidants were commercially available from Ciba Specialty Chemicals Inc. The 4-hydroxy-TEMPO was commercially available from A. H. Marks.

TABLE XXI

| Component | Ex. 47 | Ex. 48 | Ex. 49 | Ex. 50 | Ex. 51 |
|---|---|---|---|---|---|
| 4-hydroxy-TEMPO | 0.1 | 0.2 | 0.3 | 0.4 | 0.5 |

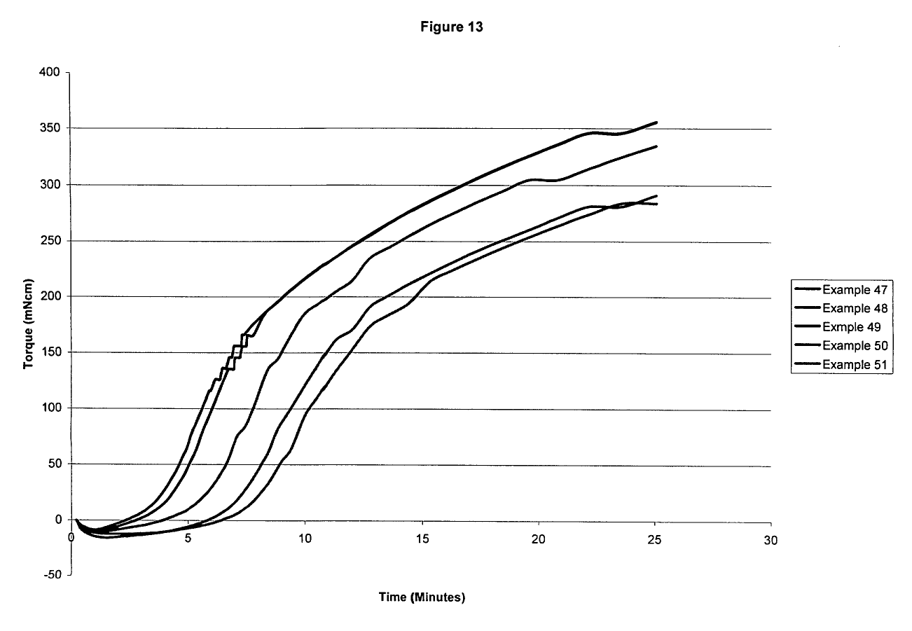

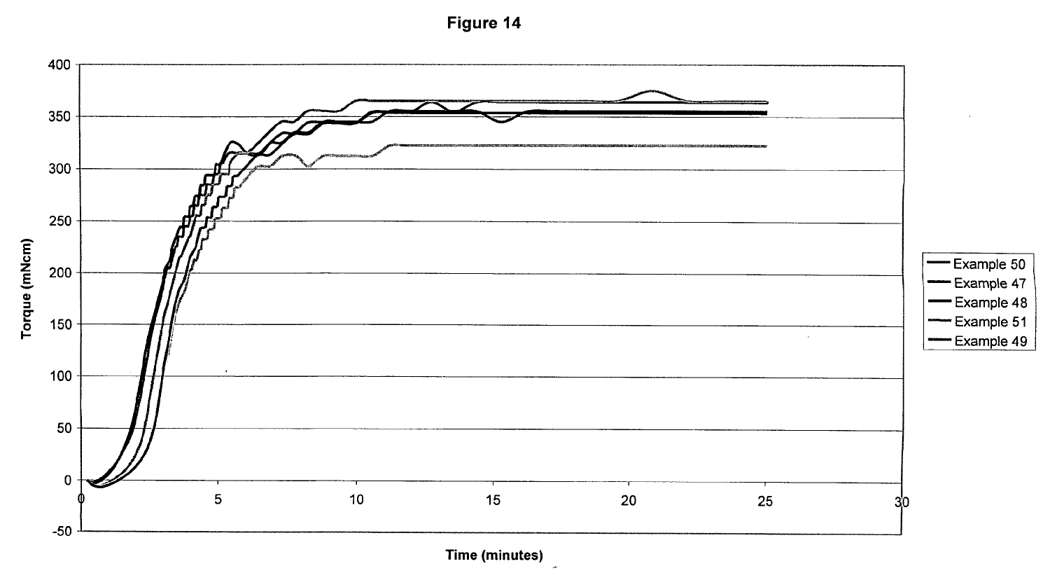

See FIGS. 13 and 14 show torque-time curves at 165 degrees Celsius and 185 degrees Celsius respectively for the exemplified compositions.

### FR Polyolefin/Modifier Masterbatch E

A Flame Retardant (FR) Polyolefin/Modifier Masterbatch E containing a crosslinking temperature-profile modifier was prepared with ethylene/vinylacetate copolymer, PGA-SD White alumina trihydrate (ATH), Irganox 1010™ tetrakismethylene(3,5-di-t-butyl-4-hydroxylhydrocinnamate)methane, Vulcup R cure accelerator, and 4-hydroxy-TEMPO.

Elvax™ 460 ethylene/vinyl acetate copolymer contained 18 percent vinyl acetate by weight and had a melt index of 2.5 grams per 10 minutes. The EVA was commercially available from DuPont.

PGA-SD White alumina trihydrate (ATH) was commercially available from Almatis. Irganox 1010™ tetrakismethylene(3,5-di-t-butyl-4-hydroxylhydrocinnamate)methane was a primary antioxidant and available from Ciba Specialty Chemicals Inc. Vulcup R cure accelerator was commercially available from Geo Specialty Chemicals. The 4-hydroxy-TEMPO was commercially available from A. H. Marks.

The amount used to prepare the FR Polyolefin/Modifier Masterbatch E are shown in Table XXII as weight percents.

TABLE XXII

| Component | FR Polyolefin/Modifier Masterbatch E |
|---|---|
| EVA | 42.80 |
| ATH | 50.00 |
| Irganox 1010 ™ | 0.20 |
| Vulcup R cure accelerator | 4.00 |
| 4-hydroxy-TEMPO | 3.00 |

### Peroxide/FR Polyolefin Masterbatch F

A peroxide-containing crosslinkable polymer was selected as the Peroxide/FR Polyolefin Masterbatch F. The selected composition was commercially available as XL 7414 peroxide-crosslinkable FR compound from Equistar.

### Example 52 and Comparative Example 53

A quantity of the FR Polyolefin/Modifier Masterbatch E was added to a quantity of Peroxide/ FR Polyolefin Masterbatch F to prepare a free-radical crosslinkable polymer composition for use in the present invention, Example 52. Example 52 was compared to a quantity of Peroxide/FR Polyolefin Masterbatch F in the absence of the crosslinking temperature profile modifier, Comparative Example 53.

The amounts used to prepare Example 52 and Comparative Example 53 are shown in Table XXIII as weight percents.

TABLE XXIII

| | | Comparative |
|---|---|---|
| Component | Example 52 | Example 53 |
| Peroxide/FR Polyolefin Masterbatch F | 95.00 | 100.00 |
| FR Polyolefin/Modifier Masterbatch E | 5.00 | |

The crosslinking kinetics of Example 52 and Comparative Example 53 were investigated using MDR at 140 degrees Celsius (to simulate melt processing conditions where premature crosslinking is not desirable) and at 182 degrees Celsius (to simulate crosslinking conditions in which rapid and effective crosslinking is desirable). At 140 degrees Celsius, longer induction times are preferable. At 182 degrees Celsius, shorter times to the desired torque are preferable, particularly when accompanied by high crosslinking densities (or higher ultimate torque). At 182 degrees Celsius, the desired initial crosslinking torque is 16.0 pound-inches.

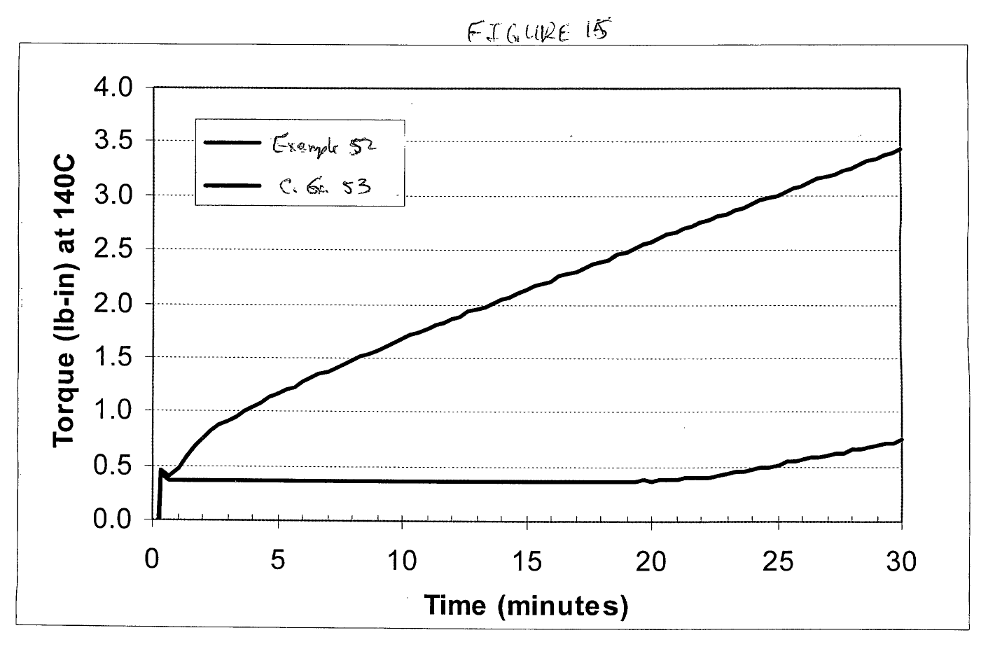

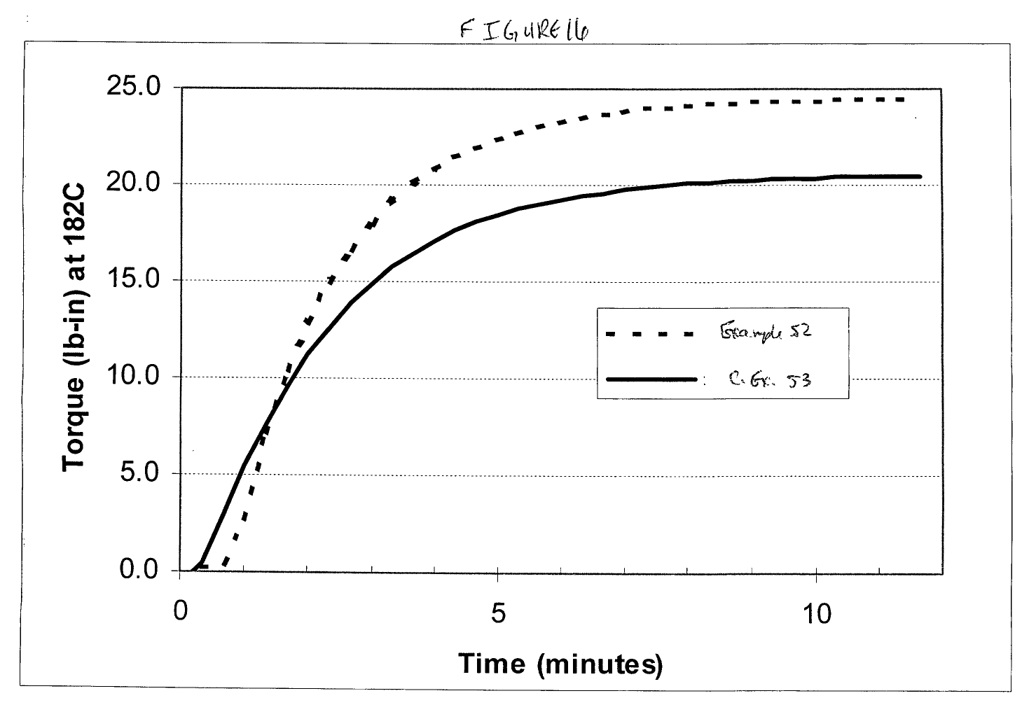

FIG. 15 showed torque-time curves at 140 degrees Celsius while FIG. 16 showed the torque-time curves at 182 degrees Celsius.

Example 52 and Comparative Example 53 were processed to make extruded articles. Table XXIV shows the process condition for the melt processing (both Die Temp. and Melt Temp.) of the extruded articles. All temperatures are reported in degrees Celsius. All screw speeds are reported in revolutions per minute (RPM), and all pressures are reported in pounds per square-inch (psi).

The surface quality of the parts is reported in the column labeled “Surface.” A “rough” surface is indicative of premature crosslinking.

TABLE XXIV

| Example | Die Temp. | Melt Temp. | Screw Speed | Pressure | Surface |
|---|---|---|---|---|---|
| Ex. 52 | 140 | 158 | 20 | 680 | smooth |
| Ex. 52 | 140 | 158 | 30 | 810 | smooth |
| Ex. 52 | 150 | 171 | 20 | 720 | smooth |
| Ex. 52 | 150 | 170 | 30 | 880 | smooth |
| Ex. 52 | 160 | 186 | 30 | 950 | rough |
| C. Ex. 53 | 120 | 131 | 20 | 900 | smooth |
| C. Ex. 53 | 140 | 162 | 20 | 860 | rough |
| C. Ex. 53 | 150 | 174 | 20 | 1000 | lump |

### FR Polyolefin Example 54 and Comparative Example 55

A flame retardant polyolefin example and comparative example were prepared with ethylene/vinyl acetate (EVA) copolymer, PGA-SD White alumina trihydrate (ATH), Kadox 911P heat stabilizer, distearyl-3-3-thiodiproprionate (DSTDP), Irganox 1010™ tetrakismethylene(3,5-di-t-butyl-4-hydroxylhydrocinnamate)methane, SR 350 cure booster, Silane A-151 coupling agent, zinc stearate, and Vulcup R organic peroxide. The flame retardant Example 54 also contained 4-hydroxy-TEMPO.

Elvax™ 460 ethylene/vinyl acetate copolymer contained 18 percent vinyl acetate by weight and had a melt index of 2.5 grams per 10 minutes. The EVA was commercially available from DuPont.

PGA-SD White alumina trihydrate (ATH) was commercially available from Almatis. Kadox 91 1P heat stabilizer was commercially available from Zinc Corporation of America. Irganox 1010™ tetrakismethylene(3,5-di-t-butyl-4-hydroxylhydrocinnamate)methane was a primary antioxidant and available from Ciba Specialty Chemicals Inc. DSTDP was a secondary antioxidant and available from Great Lakes Chemical Corporation. SR 350 cure booster was commercially available from Sartomer Company, Inc. Silane A-151 coupling agent was commercially available from GE Silicones. Zinc stearate was commercially available from Baerlocher. Vulcup R organic peroxide was commercially available from Geo Specialty Chemicals. The 4-hydroxy-TEMPO was commercially available from A. H. Marks.

The amounts used to prepare Example 54 and Comparative Example 55 are shown in Table XXV as weight percents. All components for each composition were melt blended in a Brabender mixer.

TABLE XXV

| Components | Example 54 | Comparative Example 55 |
|---|---|---|
| EVA | 43.5 | 44.0 |
| ATH | 48.3 | 48.6 |
| heat stabilizer | 2.2 | 2.2 |
| primary antioxidant | 0.7 | 0.7 |
| secondary antioxidant | 1.5 | 1.5 |
| cure booster | 0.8 | 0.8 |
| coupling agent | 0.6 | 0.6 |
| zinc stearate | 0.4 | 0.4 |
| organic peroxide | 1.7 | 1.2 |
| 4-hydroxy-TEMPO | 0.3 | |

The crosslinking kinetics of Example 54 and Comparative Example 55 were investigated using MDR at 140 degrees Celsius (to simulate melt processing conditions where premature crosslinking is not desirable) and at 182 degrees Celsius (to simulate crosslinking conditions in which rapid and effective crosslinking is desirable). At 140 degrees Celsius, longer induction times are preferable. At 182 degrees Celsius, shorter times to the desired torque are preferable, particularly when accompanied by high crosslinking densities (or higher ultimate torque).

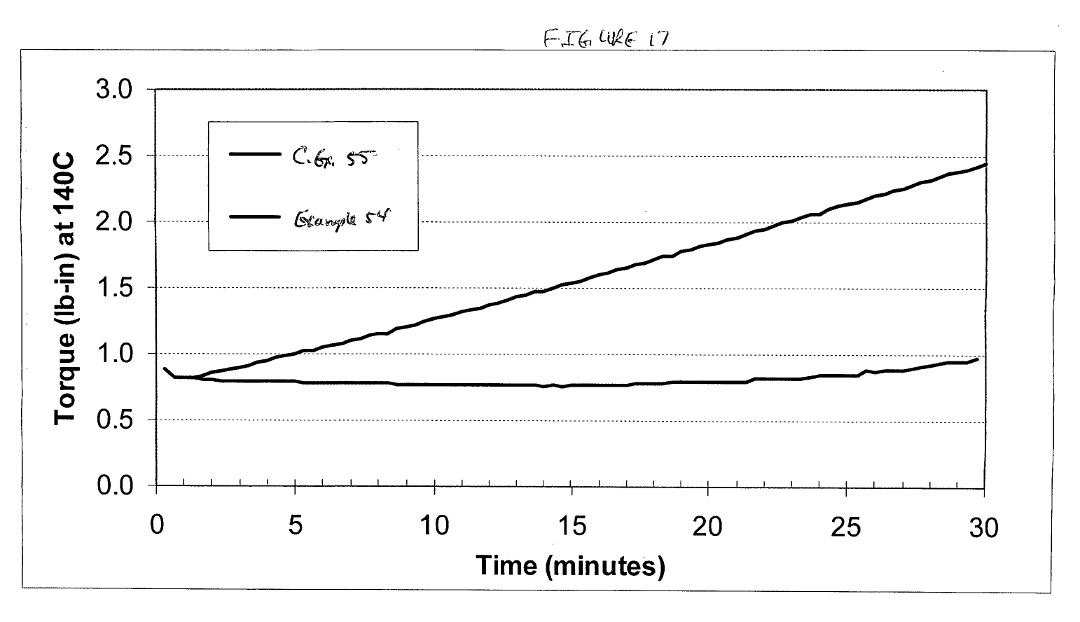

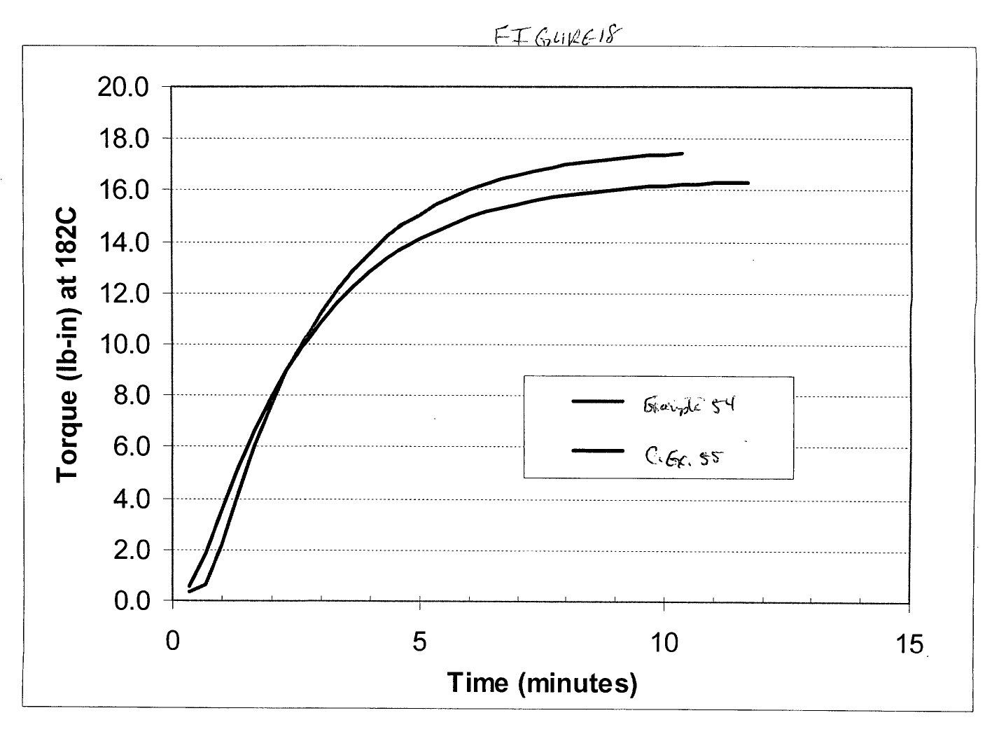

FIG. 17 showed torque-time curves at 140 degrees Celsius while FIG. 18 showed the torque-time curves at 182 degrees Celsius.

### Ethylene/Vinylacetate-Based Semiconductive Composition Comparative Examples 56, 57, and 60 and Examples 58, 59, 61 and 62

Three comparative examples and four examples were prepared with peroxide-containing HFDA-0802 semiconductive EVA-based composition. The compositions exemplifying the present invention also contained 4-hydroxy-TEMPO. In some instances, the exemplified compositions also contained a cure booster, triallyl cyanurate (TAC).

The HFDA-0802 semiconductive insulation shield composition was commercially available from The Dow Chemical Company. The 4-hydroxy-TEMPO was commercially available from A. H. Marks. The triallyl cyanurate was commercially available from Sartomer Company, Inc.

The amounts used to prepare the comparative examples and the examples are shown in Table XXVI as weight percents.

TABLE XXVI

| | C. Ex. | C. Ex. | Ex. | Ex. | C. Ex. | Ex. | Ex. |
|---|---|---|---|---|---|---|---|
| Component | 56 | 57 | 58 | 59 | 60 | 61 | 62 |
| semiconductive | 100 | 99.5 | 99.4 | 99.3 | 99.0 | 98.9 | 98.8 |
| composition | | | | | | | |
| triallyl | | 0.5 | 0.5 | 0.5 | 1.0 | 1.0 | 1.0 |
| cyanurate | | | | | | | |
| 4-hydroxy- | | | 0.1 | 0.2 | | 0.1 | 0.2 |
| TEMPO | | | | | | | |

MDR: 182 degrees Celsius, 12 minutes

| | | | | | | | |
|---|---|---|---|---|---|---|---|
| Maximum | 12.94 | 20.22 | 18.06 | 16.19 | 23.56 | 21.47 | 20.95 |
| Torque, MH | | | | | | | |
| (lb-in) | | | | | | | |

MDR: 140 degrees Celsius

| | | | | | | | |
|---|---|---|---|---|---|---|---|
| Minimum | 1.48 | 1.33 | 1.3 | 1.33 | 1.12 | 1.22 | 1.21 |
| Torque, ML | | | | | | | |
| (lb-in) | | | | | | | |
| Onset of | 0 | 0 | 10 | 24 | 0 | 10 | 21 |
| Torque In- | | | | | | | |
| crease | | | | | | | |
| (minutes) | | | | | | | |
| TS1 (minutes) | 14.97 | 13.43 | 25.74 | 42.17 | 11.82 | 25.67 | 36.83 |

### CPE Example 63 and Comparative Example 64

A peroxide-crosslinkable chlorinated polyethylene example and comparative example were prepared with TYRIN™ CM0836 chlorinated polyethylene. The compositions also contained CSX-618 carbon black, SR350 cure booster, and Dicup R organic peroxide. The peroxide-crosslinkable composition exemplifying the present invention further contained 4-hydroxy-TEMPO.

The TYRIN™ CM0836 chlorinated polyethylene contained 36% chlorine and had a Mooney Viscosity of 94 at 121 degrees Celsius. It was commercially available from DuPont Dow Elastomers, L.L.C.

The carbon black was commercially available from Cabot Corporation. The SR350 cure booster was commercially available from Sartomer Company, Inc. The dicumyl peroxide (DiCup R) was an organic peroxide and commercially available from Geo Specialty Chemicals. The 4-hydroxy-TEMPO was commercially available from A. H. Marks.

The amounts used to prepare Example 63 and Comparative Example 64 are shown in Table XXVII as weight percents. Both compositions were melt blended in a Brabender mixer.

TABLE XXVII

| Component | Example 63 | Comparative Example 64 |
|---|---|---|
| CPE | 73.4 | 74.0 |
| Carbon black | 23.0 | 23.0 |
| SR350 | 1.5 | 1.5 |
| DiCup R | 2.0 | 1.5 |
| 4-hydroxy-TEMPO | 0.1 | |

The crosslinking kinetics of Example 63 and Comparative Example 64 were investigated using MDR at 120 degrees Celsius and 140 degrees Celsius (to simulate melt processing conditions where premature crosslinking is not desirable) and at 182 degrees Celsius (to simulate crosslinking conditions in which rapid and effective crosslinking is desirable). At 120 and 140 degrees Celsius, longer induction times are preferable. At 182 degrees Celsius, shorter times to the desired torque are preferable, particularly when accompanied by high crosslinking densities (or higher ultimate torque). At 205 degrees Celsius, the desired initial crosslinking torque is 40.0 pound-inches.

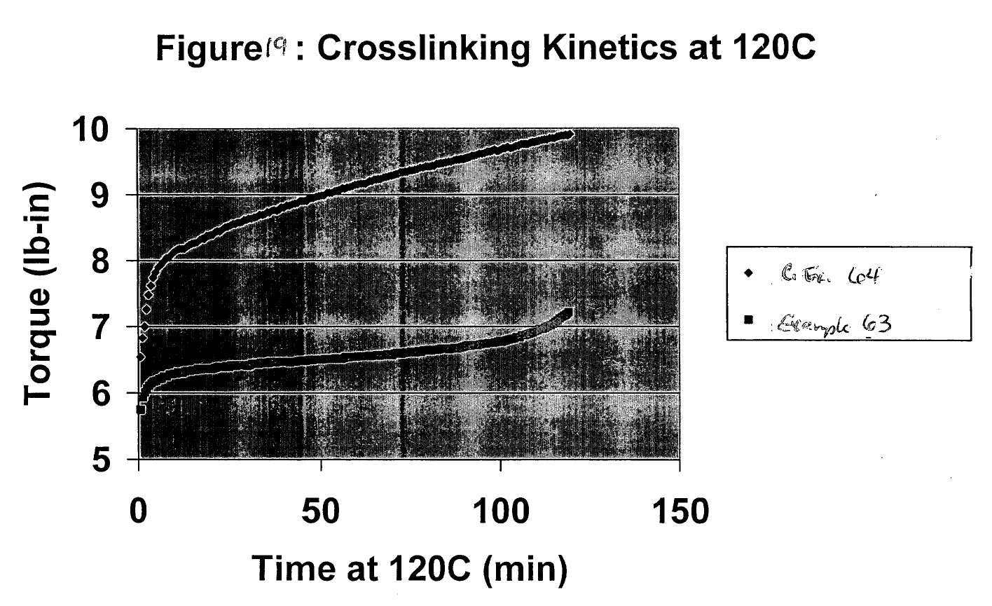

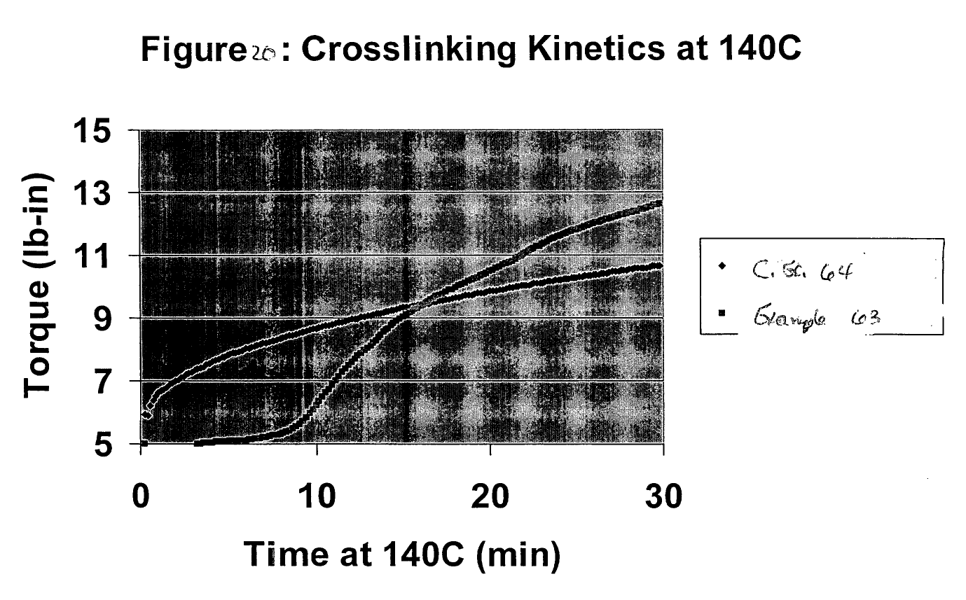

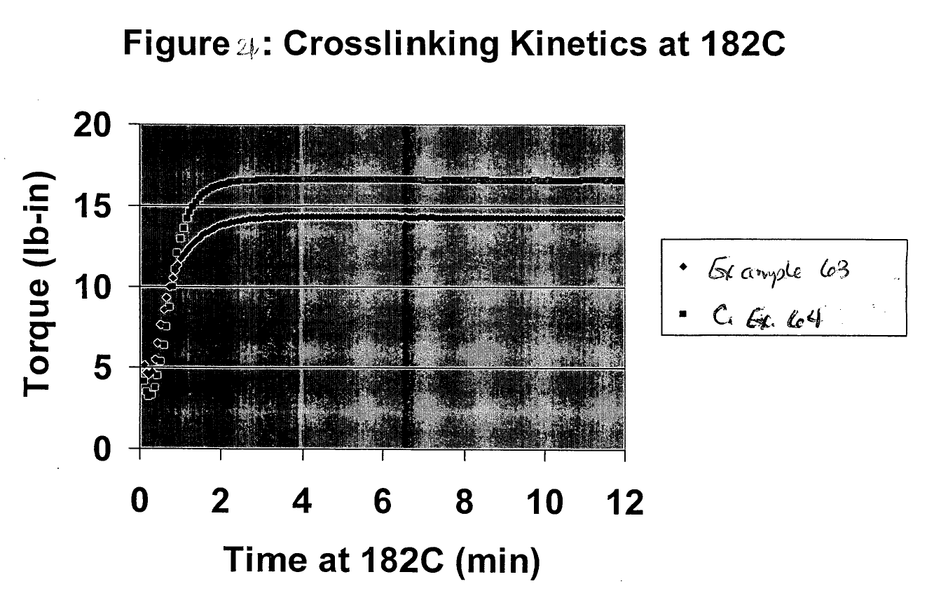

FIG. 19 showed torque-time curves at 120 degrees Celsius while FIG. 20 showed the torque-time curves at 140 degrees Celsius. FIG. 21 showed the torque-time curves at 182 degrees Celsius.

Example 63 and Comparative Example 64 were processed to make extruded articles. Table XXVIII shows the process condition for the melt processing (both Die Temp. and Melt Temp.) of the extruded articles. All temperatures are reported in degrees Celsius. All screw speeds are reported in revolutions per minute (RPM), and all pressures are reported in pounds per square-inch (psi).

The surface quality of the parts is reported in the column labeled “Surface.” A “rough” surface is indicative of premature crosslinking.

TABLE XXVIII

| Example | Die Temp. | Melt Temp. | Screw Speed | Pressure | Surface |
|---|---|---|---|---|---|
| Ex. 63 | 120 | 120 | 15 | 4500 | Smooth |
| Ex. 63 | 120 | 125 | 30 | 5900 | Smooth |
| Ex. 63 | 130 | 130 | 15 | 4600 | Smooth |
| Ex. 63 | 130 | 136 | 30 | 5700 | Smooth |
| Ex. 63 | 140 | 140 | 15 | 4800 | Rough |
| Ex. 63 | 140 | 147 | 30 | 6100 | Rough |
| C. Ex. 64 | 110 | 110 | 15 | 5500 | Rough |
| C. Ex. 64 | 120 | 120 | 15 | 4800 | Lump |

### Polyolefin Plastomer Example 65 and Comparative Example 66

A polyolefin plastomer example and comparative example were prepared with Affinity™ EG 8200 polyolefin plastomer and Dicup R organic peroxide. The polyolefin plastomer Example 1 also contained p-nitroso-N,N′-dimethylaniline.

Affinity™ EG 8200 polyolefin plastomer had a density of 0.87 grams per cubic centimeter and a melt index of 5 g/10 minutes. The polyolefin plastomer was commercially available from The Dow Chemical Company. Dicup R organic peroxide was commercially available from Geo Specialty Chemicals. The p-nitroso-N,N′-dimethylaniline was commercially available from Aldrich.

The amounts used to prepare Example 65 and Comparative Example 66 are shown in Table XXIX as weight percents. Both compositions were melt blended in a Brabender mixer.

TABLE XXIX

| Components | Example 65 | Comparative Example 66 |
|---|---|---|
| polyolefin plastomer | 98.2 | 98.5 |
| organic peroxide | 1.5 | 1.5 |
| p-nitroso-N,N′-dimethylaniline | 0.3 | |

The crosslinking kinetics of Example 65 and Comparative Example 66 were investigated using MDR at 140 degrees Celsius (to simulate melt processing conditions where premature crosslinking is not desirable) and at 182 degrees Celsius (to simulate crosslinking conditions in which rapid and effective crosslinking is desirable). At 140 degrees Celsius, longer induction times are preferable. At 182 degrees Celsius, shorter times to the desired torque are preferable, particularly when accompanied by high crosslinking densities (or higher ultimate torque).

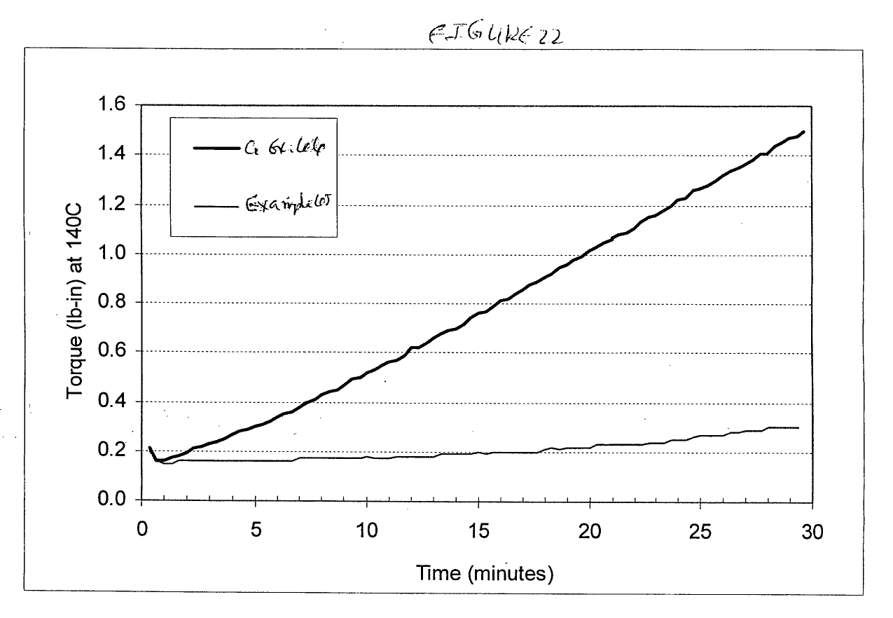

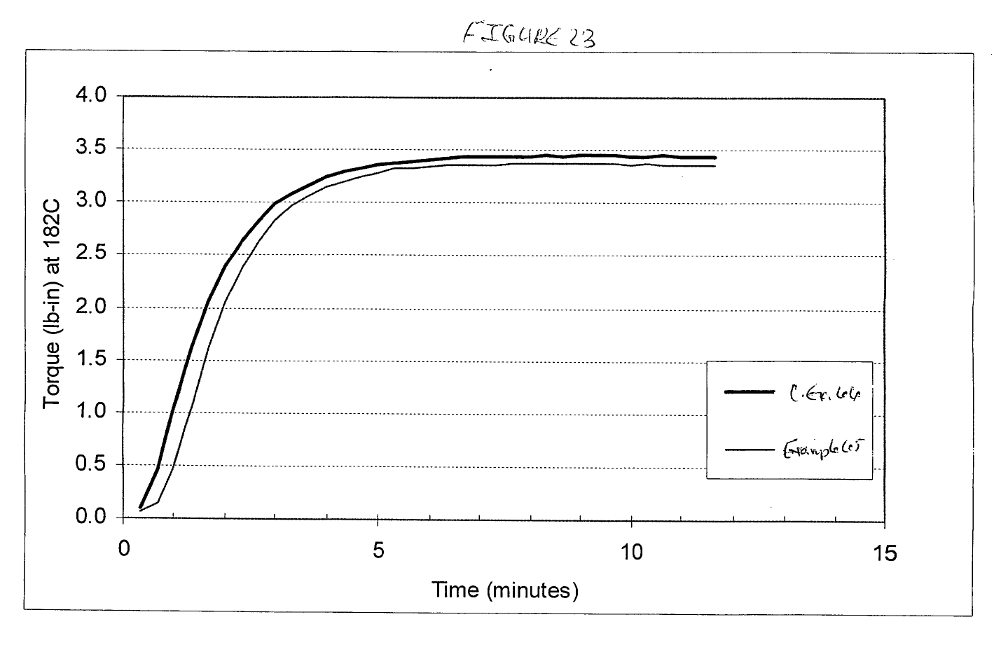

FIG. 22 showed torque-time curves at 140 degrees Celsius while FIG. 23 showed the torque-time curves at 182 degrees Celsius.

1. An improved process for preparing a crosslinked article of manufacture comprising the steps
(a) melt processing a crosslinkable polymeric composition comprising
(1) a free-radical crosslinkable polymer,
(2) a free-radical inducing species, and
(3) a crosslinking-temperature-profile modifier,
at a melt processing temperature greater than the nominal melt processing temperature of a combination of the free-radical crosslinkable polymer and the free-radical inducing species;
(b) forming an article of manufacture from the crosslinkable polymeric composition; and
(c) crosslinking the crosslinkable polymeric composition at the nominal crosslinking temperature as a formed article of manufacture.

2. The improved process of claim 1 wherein the free-radical crosslinkable polymer being hydrocarbon-based.

3. The improved process of claim 1 wherein the free-radical crosslinkable polymer is selected from the group consisting of ethylene/propylene/diene monomers, ethylene/propylene rubbers, ethylene/alpha-olefin copolymers, ethylene homopolymers, ethylene/unsaturated ester copolymers, ethylene/styrene interpolymers, halogenated polyethylene, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof.

4. The improved process of claim 3 wherein the free-radical crosslinkable polymer being a propylene polymer and the crosslinking temperature profile modifier suppresses chain scission of the propylene polymer.

5. The improved process of claim 1 wherein the free-radical inducing species being selected from the group consisting of organic peroxides, Azo free radical initiators, bicumene, oxygen, and air.

6. The improved process of claim 1 wherein the crosslinking temperature profile modifier being a free radical inhibitor.

7. The improved process of claim 6 wherein the free radical inhibitor being selected from the group consisting of (i) hindered amine-derived stable organic free radicals, (ii) iniferters, (iii) organometallic compounds, (iv) aryl azooxy radical, and (v) nitroso compounds.

8. The improved process of claim 7 wherein the free radical inhibitor being a hindered amine-derived stable organic free radical selected from the group consisting of 2,2,6,6,-tetramethyl piperidinyl oxy (TEMPO) and derivatives thereof.

9. The improved process of claim 8 wherein the stable organic free radical being a derivative of 2,2,6,6,-tetramethyl piperidinyl oxy selected from the group consisting of bis-TEMPOs, oxo-TEMPO, 4-hydroxy-TEMPO, esters of 4-hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, and metal complexes with TEMPO.

10. The improved process of claim 7 wherein the free radical inhibitor being an iniferter selected from the group consisting of tetraethyl thiuram disulfide, benzyl NN diethyldithiocarbamate, dithiocarbamates, polythiocarbamates, and S benzyl dithiocarbamate.

11. The improved process of claim 1 wherein the crosslinkable polymeric composition achieves the same degree of cure or a higher degree of cure than the combination would achieve in the absence of the crosslinking-temperature-profile modifier.

12. The improved process of claim 1 wherein the crosslinkable polymeric composition further comprises a cure booster.

13. The improved process of claim 1 wherein the free-radical crosslinkable polymeric composition further comprises a catalyst for increasing free-radical formation, selected from the group consisting of tertiary amines, cobalt naphthenate, manganese naphthenate, vanadium pentoxide, and quaternary ammonium salt.

14. An improved process for preparing a crosslinked article of manufacture comprising melt processing a crosslinkable polymeric composition comprising
(1) a free-radical crosslinkable polymer,
(2) a free-radical inducing species, and
(3) a crosslinking-temperature-profile modifier,
at a melt processing temperature greater than the nominal melt processing temperature of a combination of the free-radical crosslinkable polymer and the free-radical inducing species.

15. (canceled)

16. An improved process for preparing a crosslinked article of manufacture comprising the steps
(a) melt processing a crosslinkable polymeric composition comprising
(1) a free-radical crosslinkable polymer,
(2) a free-radical inducing species, and
(3) a crosslinking-temperature-profile modifier,
wherein
(i) in the absence of the crosslinking-temperature-profile modifier, a combination of the free-radical crosslinkable polymer and the free-radical inducing species has a nominal processing rate and
(ii) the crosslinking-temperature-profile modifier permits running the process at least about 5 percent faster than the nominal processing rate, and
at a melt processing temperature greater than the nominal melt processing temperature of a combination of the free-radical crosslinkable polymer and the free-radical inducing species;
(b) forming an article of manufacture from the crosslinkable polymeric composition; and
(c) crosslinking the crosslinkable polymeric composition as a formed article of manufacture.

17. The improved process of claim 16 wherein the crosslinking step occurs at a temperature greater than the nominal crosslinking temperature.

18-23. (canceled)

24. An improved process for preparing a crosslinked article of manufacture comprising melt processing a crosslinkable polymeric composition comprising
(1) a free-radical crosslinkable polymer,
(2) a free-radical inducing species, and
(3) a crosslinking-temperature-profile modifier wherein TS 1 being an indication of premature crosslinking of a combination of the free-radical crosslinkable polymer and the free-radical inducing species,
at a melt processing temperature greater than the nominal melt processing temperature while maintaining TS1 at least equal to the TS1 of a combination of the free-radical crosslinkable polymer and the free-radical inducing species at the nominal melt processing temperature.

25. The improved process of any of claims 23 wherein TS1 of the combination being at least 20 minutes.

26. The improved process of a of claims 23 wherein, at the melt processing temperature, the processing rate being at least about 5 percent faster than the nominal processing rate.

27. An improved process for preparing an expanded, crosslinked article of manufacture comprising the steps of
(a) injecting at an injection temperature an expandable, free-radical crosslinkable polymeric composition of into a mold at a mold temperature, wherein the expandable, free-radical crosslinkable polymeric composition comprises
(A1) a free-radical crosslinkable polymer;
(A2) a free-radical inducing species;
(A3) a crosslinking-temperature-profile modifier; and
(A4) a blowing agent selected from the group consisting of chemical blowing agents and physical blowing agents;
(b) heating the expandable, free-radical crosslinkable polymeric composition for a period of time to a crosslinking temperature sufficient to expand and crosslink the expandable, crosslinkable polymeric composition;
